(19) United States
(12) Patent Application Publication
(10) Pub. No.: US 2026/0138695 A1
(43) Pub. Date: May 21, 2026

(54) LAMP SYSTEM, LIGHT DISTRIBUTION CONTROL APPARATUS AND COMPUTER PROGRAM

(71) Applicant: Koito Manufacturing Co., Ltd., Tokyo (JP)

(72) Inventors: Hiroki SUMITANI, Shizuoka-shi (JP); Takuya KATAOKA, Shizuoka-shi (JP)

(73) Assignee: Koito Manufacturing Co., Ltd., Tokyo (JP)

(21) Appl. No.: 19/447,097

(22) Filed: Jan. 13, 2026

Related U.S. Application Data
(63) Continuation of application No. PCT/JP2024/023837, filed on Jul. 1, 2024.

(30) Foreign Application Priority Data
Jul. 27, 2023 (JP) 2023-122438
Jul. 27, 2023 (JP) 2023-122439

(51) Int. Cl. B62J 6/024; B62J 6/027; B62J 45/41; B62J 45/42; H05B 47/125

(52) U.S. Cl. CPC B62J 6/024; B62J 6/027; B62J 45/41; B62J 45/42; H05B 47/125

(57) ABSTRACT

A lamp system includes: an imaging apparatus; a variable light distribution lamp; a first bracket that supports the imaging apparatus; a second bracket that supports the variable light distribution lamp such that an irradiation direction is variable and that is independently displaceable with respect to the first bracket; an irradiation direction sensor; and a light distribution control apparatus that detects an object, defines a position of a shielded-light portion based on a mutual correspondence between an imaging direction and an irradiation direction, and controls the variable light distribution lamp to form the light distribution pattern having the shielded-light portion. The light distribution control apparatus defines, when the irradiation direction is changed, the shielded-light portion at a position shifted from the position of the shielded-light portion defined based on a pre-change correspondence by an amount determined by the amount of change.

### CROSS-REFERENCE TO RELATED APPLICATIONS

This application is the continuation of International Patent Application No. PCT/JP2024/023837, filed on Jul. 1, 2024, which claims the benefit of priority from Japanese Patent Application No. 2023-122438, filed on Jul. 27, 2023 and Japanese Patent Application No. 2023-122439, filed on Jul. 27, 2023, the entire content of each of which is incorporated herein by reference.

### BACKGROUND

### Field of the Invention

The present disclosure relates to a lamp system, a light distribution control apparatus, and a computer program.

### Description of the Related Art

ADB (Adaptive Driving Beam) control for controlling a light distribution pattern dynamically and adaptively based on the condition around a vehicle is known (see, for example, Patent literature 1). ADB control is configured to detect the presence or absence of a vehicle in front for which high-luminance light irradiation should be avoided with a camera and to shield light in a region corresponding to the vehicle in front. Shielding light in a region corresponding to the vehicle in front and irradiating other regions with light can reduce glare experienced by the driver of the vehicle in front and, at the same time, improve viewability for the driver of the driver's vehicle.
[Patent literature 1] WO2019/176418

In lamp systems mounted on vehicles in general, the irradiation direction of the headlamp is adjusted by performing aiming adjustment. In a configuration in which the imaging direction of the camera and the irradiation direction of the lamp can be relatively displaced (e.g., when the camera and the headlamp are mounted on different brackets), the correspondence between the imaging direction and the irradiation direction could be changed from what was known in advance. In this case, a shift could be created between the object detected by the camera and the shielded-light portion formed for the object.

### SUMMARY

The present disclosure addresses the issue described above, and a purpose thereof is to provide a technology for forming a shielded-light portion with high accuracy.

1. An embodiment of the present disclosure that addresses the above issue relates to a lamp system. The lamp system includes: an imaging apparatus that images a scene in front of a vehicle; a variable light distribution lamp capable of forming a light distribution pattern having a shielded-light portion; a first bracket that supports the imaging apparatus; a second bracket that supports the variable light distribution lamp such that an irradiation direction is variable and that is independently displaceable with respect to the first bracket; an irradiation direction sensor that detects an amount of change in the irradiation direction; and a light distribution control apparatus that detects an object by using an image based on the imaging apparatus, defines a position of the shielded-light portion corresponding to the object based on a mutual correspondence between an imaging direction of the imaging apparatus and the irradiation direction, and controls the variable light distribution lamp to form the light distribution pattern having the shielded-light portion. The light distribution control apparatus defines, when the irradiation direction is changed, the shielded-light portion at a position shifted from the position of the shielded-light portion defined based on a pre-change correspondence by an amount determined by the amount of change.

Another embodiment of the present disclosure relates to a light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion. The light distribution control apparatus: acquires a detection result from an irradiation direction sensor that detects an amount of change in the irradiation direction, and defines, when the irradiation direction is changed, the shielded-light portion at a position shifted from the position of the shielded-light portion defined based on a pre-change correspondence by an amount determined by the amount of change.

Another embodiment of the present disclosure relates to a light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion. While the imaging direction is fixed with respect to the object which remains at the same position relative to the vehicle, the light distribution control apparatus defines the shielded-light portion at a first position in the light distribution pattern when the imaging direction and the irradiation direction are in a first correspondence and defines the shielded-light portion at a second position in the light distribution pattern shifted from the first position when the imaging direction and the irradiation direction are in a second correspondence different from the first correspondence.

Another embodiment of the present disclosure relates to a computer program executed by a light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion. The computer program causes the light distribution control apparatus to execute a function of acquiring a detection result from an irradiation direction sensor that detects an amount of change in the irradiation direction and defining, when the irradiation direction is changed, the shielded-light portion at a position shifted from the position of the shielded-light portion defined based on a pre-change correspondence by an amount determined by the amount of change.

2. An embodiment of the present disclosure that addresses the above issue relates to a lamp system. The lamp system includes: an imaging apparatus that images a scene in front of a vehicle; a variable light distribution lamp capable of forming a light distribution pattern having a shielded-light portion; a first bracket that supports the imaging apparatus; a second bracket that supports the variable light distribution lamp such that an irradiation direction is variable and that is independently displaceable with respect to the first bracket; an irradiation direction sensor that detects an amount of change in the irradiation direction; and a light distribution control apparatus that sets, in an image based on the imaging apparatus, a processing region based on a mutual correspondence between an imaging direction of the imaging apparatus and the irradiation direction, performs an object detection process in the processing region to detect an object, and controls the variable light distribution lamp to form a light distribution pattern having a shielded-light portion corresponding to the object. The light distribution control apparatus defines, when the irradiation direction is changed, the processing region at a position shifted from the position of the processing region defined based on a pre-change correspondence by an amount determined by the amount of change.

Another embodiment of the present disclosure relates to a light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object. The light distribution control apparatus: acquires a detection result from an irradiation direction sensor that detects an amount of change in the irradiation direction, and defines, when the irradiation direction is changed, the processing region at a position shifted from the position of the processing region defined based on a pre-change correspondence by an amount determined by the amount of change.

Another embodiment of the present disclosure relates to a light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object. While the imaging direction is fixed with respect to the object which remains at the same position relative to the vehicle, the light distribution control apparatus defines the shielded-light portion in the light distribution pattern when the imaging direction and the irradiation direction are in a first correspondence and does not define the shielded-light portion in the light distribution pattern when the imaging direction and the irradiation direction are in a predetermined second correspondence different from the first correspondence.

Another embodiment of the present disclosure relates to a computer program executed by a light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object. The computer program causes the light distribution control apparatus to execute a function of acquiring a detection result from an irradiation direction sensor that detects an amount of change in the irradiation direction and defining, when the irradiation direction is changed, the processing region at a position shifted from the position of the processing region defined based on a pre-change correspondence by an amount determined by the amount of change.

Optional combinations of the aforementioned constituting elements, and implementations of the present disclosure in the form of methods, apparatuses, systems, etc. may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a lamp system according to embodiments 1, 3;

FIG. 2A, FIG. 2B, FIG. 2C, and FIG. 2D illustrate the basic operation of light distribution control;

FIG. 3A, FIG. 3B, FIG. 3C, and FIG. 3D show a case in which the basic operation is performed in a situation where the mutual correspondence between the irradiation direction and the imaging direction changes from that of initial aiming;

FIG. 4 is a schematic diagram to illustrate a method to correct the correspondence;

FIG. 5A, FIG. 5B, FIG. 5C, and FIG. 5D illustrate light distribution control that accompanies correction of the correspondence;

FIG. 6 is a flowchart illustrating an example of control executed by the light distribution control apparatus;

FIG. 7 is a block diagram of the lamp system according to embodiments 2, 4;

FIG. 8A, FIG. 8B, FIG. 8C, and FIG. 8D show a case in which the basic operation is performed in a situation where the mutual correspondence between the irradiation direction and the imaging direction changes from that of initial aiming; and

FIG. 9A, FIG. 9B, FIG. 9C, and FIG. 9D illustrate light distribution control in embodiment 3 that accompanies correction of the correspondence.

### DETAILED DESCRIPTION OF THE INVENTION

Hereinafter, the present disclosure will be described based on a preferred embodiment with reference to the accompanying drawings. The embodiments do not limit the scope of the invention but exemplify the invention. Not all of the features and the combinations thereof described in the embodiments are necessarily essential to the invention. Identical or like constituting elements, members, processes shown in the drawings are represented by identical symbols and a duplicate description will be omitted as appropriate.

The scales and shapes of the parts shown in the figures are defined for convenience's sake to make the explanation easy and shall not be interpreted limitatively unless otherwise specified. Terms like “first”, “second”, etc. used in the specification and claims do not indicate an order or importance by any means unless specified otherwise and are used to distinguish a certain feature from the others. Those of the members that are not material to the description of the embodiments are omitted in the drawings.

### Embodiment 1

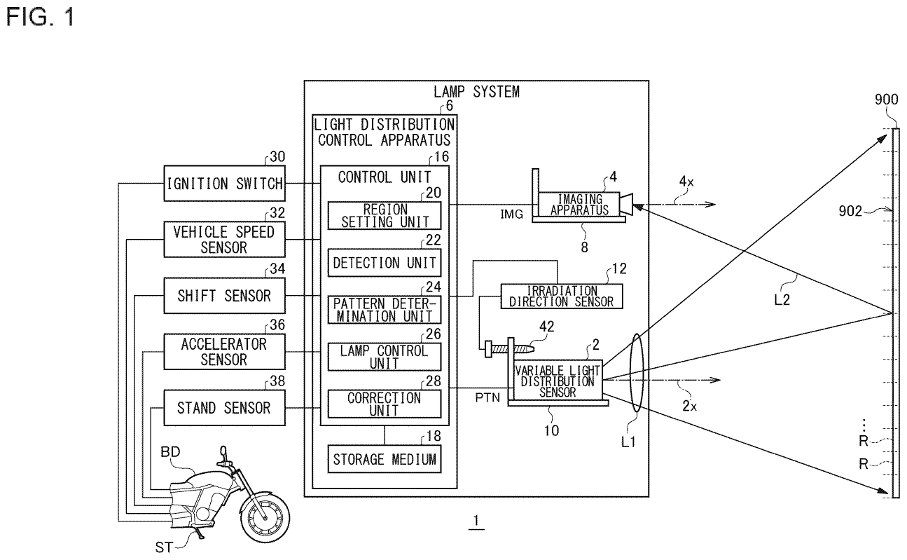

FIG. 1 is a block diagram of a lamp system 1 according to embodiment 1. FIG. 1 depicts the constituting elements of the lamp system 1 as functional blocks. The functional blocks are implemented in hardware such as devices and circuits exemplified by a CPU and a memory of a computer, and in software such as a computer program. It will be understood by those skilled in the art that these functional blocks may be implemented in a variety of forms by combinations of hardware and software.

The lamp system 1 is equipped with a variable light distribution lamp 2, an imaging apparatus 4, a light distribution control apparatus 6, a first bracket 8, a second bracket 10, and an irradiation direction sensor 12. These are mounted on the vehicle. In the embodiment, the vehicle equipped with the lamp system 1 is a rideable saddle vehicle such as a motorcycle by way of example.

The mechanisms including the variable light distribution lamp 2, the imaging apparatus 4, the light distribution control apparatus 6, the first bracket 8, the second bracket 10, and the irradiation direction sensor 12 mentioned above may all be built into the same housing, or several mechanisms may be provided outside the housing. For example, the mechanisms are housed in a lamp chamber. The lamp chamber is defined by a lamp body having an opening on the frontward side of the vehicle and a translucent cover attached to cover the opening of the lamp body.

The imaging apparatus 4, the light distribution control apparatus 6, the first bracket 8, and the irradiation direction sensor 12 may be provided outside the lamp chamber (e.g., on the vehicle side). In this case, the imaging apparatus 4 may be a vehicle-mounted camera. In the case the imaging apparatus 4 is a vehicle-mounted camera, a vehicle body BD may represent the first bracket 8. Further, the light distribution control apparatus 6 may, for example, be comprised of a vehicle ECU entirely or in part.

The variable light distribution lamp 2 is capable of radiating a variable intensity distribution visible light beam L1 to a region in front of the driver's vehicle. The variable light distribution lamp 2 can individually vary that illuminance of light irradiating a plurality of individual regions R arranged in the region in front. In other words, the variable light distribution lamp 2 can irradiate the space in front of the driver's vehicle with a light having an illuminance that varies depending on the location (individual region R). The plurality of individual regions R may, for example, be arranged in a row in the vehicle width direction or arranged in a matrix. The variable light distribution lamp 2 receives information designating a light distribution pattern PTN from the light distribution control apparatus 6 and outputs the visible light beam L1 having an intensity distribution determined by the light distribution pattern PTN. Thereby, the light distribution pattern PTN is formed in front of the vehicle. The light distribution pattern PTN is understood to be a two-dimensional illuminance distribution of an irradiation pattern 902 that the variable light distribution lamp 2 forms on a vertical virtual screen 900 in front of the driver's vehicle.

The embodiment is non-limiting as to the configuration of the variable light distribution lamp 2. For example, the variable light distribution lamp 2 includes a plurality of light sources arranged in a horizontal row or in a matrix and a lighting circuit that drives the light sources individually to light the light sources. Preferable examples of the light source include a semiconductor light source such as a LED (light emitting device), a LD (laser diode), and an organic or inorganic EL (electroluminescence). Each individual region R and each light source are associated with each other, and each individual region R is individually irradiated with a light from each light source. The resolution of the variable light distribution lamp 2, i.e., the light distribution resolution, is about 4 pixels-20 pixels in the case the light sources are arranged in a horizontal row and about 1000-2000000 pixels in the case the light sources are arranged in a matrix. The resolution of the variable light distribution lamp 2 means the number of unit regions in the light distribution pattern PTN in which the illuminance can be varied independently.

For formation of an illuminance distribution determined by the light distribution pattern PTN, the variable light distribution lamp 2 may include a pattern formation device of matrix type such as a DMD (Digital Mirror Device) and a liquid crystal device or include a pattern formation device of optical scan type configured to scan an area in front of the driver's vehicle with a light from the light source. The variable light distribution lamp 2 may alternatively be a configured to partially block light irradiation of the region in front by using a shade plate.

The imaging apparatus 4 is exemplified by a camera, has sensitivity in the visible light zone, and images a scene in front of the driver's vehicle repeatedly. The imaging apparatus 4 images a reflected light L2 from an object in front of the vehicle reflecting the visible light beam L1. Further, the imaging apparatus 4 images a light radiated by vehicles in front, which include leading vehicles and oncoming vehicles, and a light radiated by a self-luminous body such as a streetlight and an electronic message board. An image IMG generated by the imaging apparatus 4 is sent to the light distribution control apparatus 6.

The image IMG acquired by the light distribution control apparatus 6 from the imaging apparatus 4 may be RAW image data or image data subjected to a predetermined image process by the imaging apparatus 4. Reception by the light distribution control apparatus 6 of image data derived from subjecting the RAW image data generated by the imaging apparatus 4 to an image process by a processing apparatus other than the imaging apparatus 4 also represents acquisition of the image IMG from the imaging apparatus 4. In the following description, “the image IMG based on the imaging apparatus 4” means whichever of RAW image data and data subjected to an image process. Both of the image data may be expressed as “image IMG” without making any distinction therebetween.

The light distribution control apparatus 6 detects an object by using the image IMG based on the imaging apparatus 4 and controls the variable light distribution lamp 2 to form the light distribution pattern PTN having a shielded-light portion corresponding to the detected object. In other words, the light distribution control apparatus 6 performs ADB control for dynamically and adaptively control the light distribution of the variable light distribution lamp 2 in accordance with an object located in the region in front. The light distribution control apparatus 6 of the embodiment detects a vehicle in front as an object. The light distribution control apparatus 6 may detect an object other than the vehicle in front. In the embodiment, the fact that the shielded-light portion “corresponds to the object” means that the shielded-light portion overlaps the object when the light distribution pattern PTN is projected forward. The light distribution control apparatus 6 sends information designating the light distribution pattern PTN to the variable light distribution lamp 2.

The light distribution control apparatus 6 may be comprised of a digital processor. For example, the light distribution control apparatus 6 may be comprised of a combination of a microcomputer, including a CPU, and a software program. The light distribution control apparatus 6 may alternatively be comprised of a FPGA (Field Programmable Gate Array), an ASIC (Application Specified IC), or the like.

The light distribution control apparatus 6 includes a control unit 16 comprised of a CPU, etc., and a storage medium 18 comprised of a memory or a storage. The control unit 16 includes a region setting unit 20, a detection unit 22, a pattern determination unit 24, a lamp control unit 26, and a correction unit 28 by way of example. The storage medium 18 stores a computer program executed by the light distribution control apparatus 6 (more specifically, the control unit 16) and information on correspondence described later. Each part included in the control unit 16 operates by executing, in the integrated circuit constituting the part, the program stored in the storage medium 18. The operation of each part will be explained later.

The control unit 16 can also receive signals sent from an ignition switch 30, a vehicle speed sensor 32, a shift sensor 34, an accelerator sensor 36, and a stand sensor 38 mounted on the vehicle. The ignition switch 30 transmits a signal indicating on/off of ignition to the control unit 16. The vehicle speed sensor 32 transmits a signal indicating the vehicle speed to the control unit 16. The shift sensor 34 transmits a signal indicating the shift position to the control unit 16. The accelerator sensor 36 transmits a signal indicating the accelerator position of the driver to the control unit 16. The stand sensor 38 transmits a signal indicating whether a stand ST supporting the vehicle body BD is in the standing position or the stowed position to the control unit 16. The lamp system 1 may be mounted on a vehicle such as a four-wheeled vehicle other than a rideable saddle vehicle. In this case, the vehicle is not equipped with a stand ST or a stand sensor 38.

The first bracket 8 supports the imaging apparatus 4. The first bracket 8 of the embodiment supports the imaging apparatus 4 such that an imaging direction 4x is immovable. The first bracket 8 has a publicly known structure. The “imaging direction 4x” of the imaging apparatus 4 can be translated into the “angle of the imaging axis” or “orientation” of the imaging apparatus 4.

The second bracket 10 supports the variable light distribution lamp 2 such that an irradiation direction 2x is variable. The second bracket 10 has a publicly known structure. The second bracket 10 by way of example has a second aiming screw 42. By rotating the second aiming screw 42, the attitude of the second bracket 10 can be changed upward, downward, leftward, or rightward so that the irradiation direction 2x of the variable light distribution lamp 2 can be tilted upward, downward, leftward, or rightward. The “irradiation direction 2x” of the variable light distribution lamp 2 can be translated into the “angle of the optical axis” or “orientation” of the variable light distribution lamp 2.

The second bracket 10 is independently displaceable with respect to the first bracket 8. Therefore, the correspondence between the imaging direction 4x and the irradiation direction 2x could change from the state set in initial aiming carried out at a vehicle manufacturer's manufacturing plant or a dealer's maintenance shop due to the displacement of the second bracket 10 that could occur during the use of the vehicle.

The irradiation direction sensor 12 can detect the amount of change in the irradiation direction 2x (amount of change in the angle) of the variable light distribution lamp 2. The irradiation direction sensor 12 includes, for example, a publicly known potentiometer and can detect the amount of change in the irradiation direction 2x by referring to the amount of rotation (rotation angle) of the second aiming screw 42. The irradiation direction sensor 12 sends a signal indicating a detection result to the control unit 16. The irradiation direction sensor 12 may send the amount of rotation (voltage determined by the amount of rotation) of the second aiming screw 42 itself to the control unit 16 as information indicating the amount of change in the irradiation direction 2x.

The structure and method of changing the irradiation direction 2x are not limited to those using the second aiming screw 42, but other publicly known structures and methods may be adopted. Further, the method of detecting the amount of change by the irradiation direction sensor 12 can be selected as appropriate in accordance with the structure and method of changing the irradiation direction 2x.

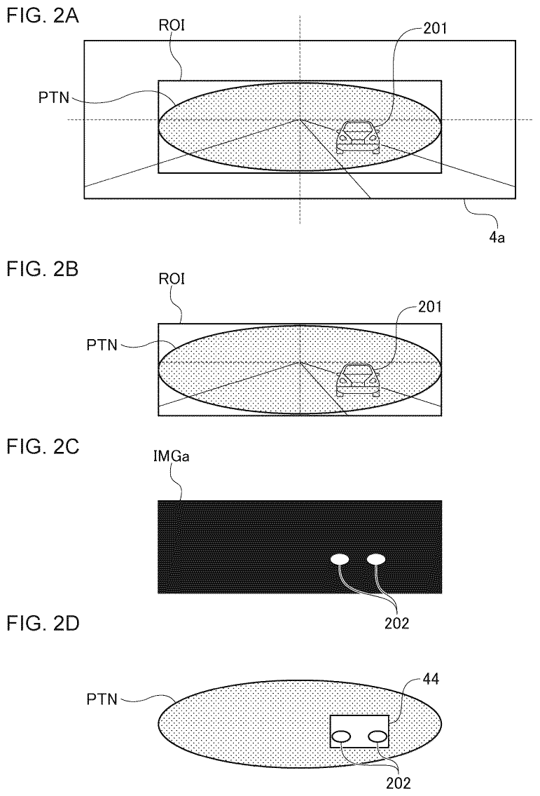

A description will now be given of the operation of the light distribution control apparatus 6. FIG. 2A, FIG. 2B, FIG. 2C, and FIG. 2D illustrate the basic operation of light distribution control. FIG. 2A shows an imaging region 4a of the imaging apparatus 4 and the light distribution pattern PTN formed in front of the vehicle. A light distribution pattern for high beam is shown as an example of the light distribution pattern PTN. Further, FIG. 2A illustrates a processing region ROI set in the image IMG (in other words, the imaging region 4a) for convenience. Further, the following description uses an oncoming car 201 as an example of an object.

When the oncoming vehicle 201 is present in front of the vehicle, the image IMG including the oncoming vehicle 201 is generated by the imaging apparatus 4 and sent to the light distribution control apparatus 6. The image IMG sent to the light distribution control apparatus 6 is acquired by the region setting unit 20. The region setting unit 20 sets the processing region ROI in the image IMG. The position where the processing region ROI should be set and the shape of the processing region ROI can be determined in advance based on an experiment or a simulation by the designer. For example, the processing region ROI is set to be a range in the image IMG that overlaps the irradiation range of the light distribution pattern PTN. Information on the processing region ROI includes position coordinates in the image IMG and is stored in the storage medium 18 in advance. The image IMG for which the processing region ROI is set is sent to the detection section 22.

The detection unit 22 extracts the processing region ROI from the image IMG as shown in FIG. 2B. The detection unit 22 then subjects the processing region ROI to a publicly known image process such as a binarization process. This generates, as shown in FIG. 2C, a light spot image IMGa in which two light spots 202 corresponding to the lamps of the oncoming vehicle 201 are extracted. The lamps of the oncoming car 201 are headlamps, etc. In the case the target of detection is a leading vehicle, the light spots 202 corresponding to the rear lamps, etc. of the leading vehicle will be included in the light spot image IMGa. The rear lamps include stop lamps and tail lamps.

The detection unit 22 determines the presence or absence of an object by using the light spot image IMGa. Execution of an object detection process in the light spot image IMGa corresponds to execution of an object detection process in the image IMG or the processing region ROI. The detection unit 22 detects the object based on the light spot 202 when the light spot 202 is included in the light spot image IMGa. For example, the detection unit 22 determines that the light spot 202 present in the processing region ROI originates from the object, i.e., determines that the object is present at the position where the light spot 202 is present.

The detection unit 22 sends a detection result to the pattern determination unit 24. Further, the object detection method carried out by the detection unit 22 is not particularly limited. For example, generation of a light spot image IMGa may be omitted, and the object may be detected from the processing region ROI by using a publicly known method including algorithm recognition and deep learning. Further, the type of object (vehicle in front, oncoming vehicle 201, leading vehicle, sign, etc.) may or may not be identified. The detection unit 22 can identify the type of object by algorithm recognition or deep learning described above or based on a publicly known indicator for judgment such as the position of the light spot 202 and pairing of the light spots 202.

When an object is detected, the pattern determination unit 24 sets a shielded-light portion 44 in a region in the base light distribution pattern corresponding to the object, as shown in FIG. 2D. This determines the light distribution pattern PTN that should be formed. The shielded-light portion 44 is a portion in the light distribution pattern PTN where the brightness (illuminance) is 0 or a portion where the brightness exceeds 0 but is lower than the pre-shading brightness. When no objects are detected, the pattern determination unit 24 defines the light distribution pattern PTN without the shielded-light portion 44.

The base light distribution pattern is selected according to the light distribution mode determined based on the driver's instruction (e.g., the manipulation of a light switch (not shown)), the traveling condition of the driver's vehicle, and the environment around the vehicle. For example, light distribution modes include a high beam mode for forming a light distribution pattern for high beam, a low beam mode for forming a light distribution pattern for low beam, and a town mode for forming a light distribution pattern suitable for urban driving. FIG. 2D shows a light distribution pattern for high beam by way of example.

The position of the shielded-light portion 44 is defined based on the mutual correspondence between the imaging direction 4x and the irradiation direction 2x. Information on this correspondence links position coordinates in the image IMG and position coordinates in the light distribution pattern PTN and is, for example, created at initial aiming and stored in the storage medium 18. Based on this correspondence, the position of the shielded-light portion 44 in the light distribution pattern PTN can be defined according to the position of the object in the light spot image IMGa. By way of example, the pattern determination unit 24 defines the shielded-light portion 44 of a predetermined shape in the light distribution pattern PTN. The pattern determination part 24 may deform the shape of the light spot 202 by applying a publicly known expansion and compression process to the light spot image IMGa and may define the deformed shape of the light spot 202 to be the shape of the shielded-light portion 44. The pattern determination unit 24 sends the information on the light distribution pattern PTN thus determined to the lamp control unit 26.

The lamp control unit 26 directs the variable light distribution lamp 2 to form the light distribution pattern PTN. The lamp control unit 26 is comprised of, for example, a publicly known LED driver module (LDM), etc. In the case the dimming method of the light source of the variable light distribution lamp 2 is analog dimming, the lamp control unit 26 adjusts the DC level of the driving current flowing in the light source. Further, in the case the dimming method of the light source is PWM (Pulse Width Modulation) dimming, the lamp control unit 26 adjusts the average level of the driving current by switching the current flowing in the light source and adjusting the ratio of the on period. Further, in the case the variable light distribution lamp 2 has a DMD, the lamp control unit 26 controls on/off switching of each mirror element constituting the DMD. In the case the variable light distribution lamp 2 includes a liquid crystal device, the lamp control unit 26 controls the light transmittance of the liquid crystal device. This forms the light distribution pattern PTN in front of the vehicle.

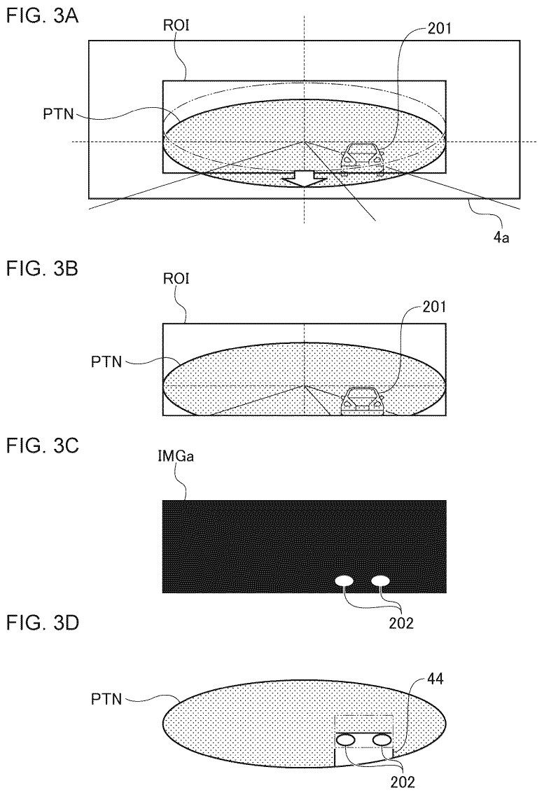

A description will now be given of position correction of the shielded-light portion 44 performed when the mutual correspondence between the irradiation direction 2x and the imaging direction 4x changes from that of initial aiming. FIG. 3A, FIG. 3B, FIG. 3C, and FIG. 3D show a case in which the basic operation is performed in a situation where the mutual correspondence between the irradiation direction 2x and the imaging direction 4x changes from that of initial aiming.

As described above, the light distribution control apparatus 6 defines the shielded-light portion 44 corresponding to the object in the light distribution pattern PTN based on the correspondence between the imaging direction 4x and the irradiation direction 2x. In such control, a situation could occur in which the shielded-light portion 44 is shifted from the object as the light distribution pattern PTN is radiated, in the case the correspondence changes from what was acquired at initial aiming.

For example, auto-leveling function has been put into practical use for adjustment of the irradiation direction 2x. In this case, the attitude of the second bracket 10 is automatically changed by the auto-leveling function before the vehicle starts running if the vehicle attitude changes due to the load, etc. This allows the irradiation direction 2x to be adjusted to an angle suited to the vehicle attitude. Alternatively, the irradiation direction 2x may be changed manually.

When the variable light distribution lamp 2 and the imaging apparatus 4 are mounted on the same bracket, it is possible to change the irradiation direction 2x while maintaining the correspondence between the irradiation direction 2x and the imaging direction 4x at initial aiming. If it is attempted to mount the variable light distribution lamp 2 and the imaging apparatus 4 on the same bracket, however, the bracket may have to have a larger size and the place where the bracket can be installed could be limited. In this case, the flexibility of arrangement of the variable light distribution lamp 2 and the imaging apparatus 4 is reduced. For this reason, it is desirable to mount the variable light distribution lamp 2 and the imaging apparatus 4 on separate brackets as in the embodiment.

When the variable light distribution lamp 2 and the imaging apparatus 4 are mounted on separate brackets, the imaging direction 4x is often fixed as in the embodiment. One of the reasons for this is that the imaging range of the imaging apparatus 4 is generally wider than irradiation range of the variable light distribution lamp 2, and the entire light distribution pattern PTN after the displacement of the irradiation direction 2x can be imaged even if the imaging direction 4x is fixed. When the variable light distribution lamp 2 and the imaging apparatus 4 are mounted on separate brackets, therefore, the mutual correspondence between the irradiation direction 2x and the imaging direction 4x could change from that of initial aiming.

When the irradiation direction 2x is changed, the relative positions of the imaging region 4a and the light distribution pattern PTN changes, as shown in FIG. 3A. In this state, the processing region ROI is set in the image IMG. Subsequently, the processing region ROI is extracted as shown in FIG. 3B, and the light spot image IMGa is generated as shown in FIG. 3C. Then, as shown in FIG. 3D, the shielded-light portion 44 is set in the region in the light distribution pattern PTN corresponding to the object.

In the basic operation, the position coordinates of the light spot 202 in the light spot image IMGa are converted to the position coordinates of the shielded-light portion 44 in the light distribution pattern PTN based on the correspondence created at initial aiming. In this case, the shielded-light portion 44 defined in the light distribution pattern PTN after the change in the irradiation direction 2x will be shifted from the position where it should be set in the direction of change of the irradiation direction 2x by an amount determined by the amount of change in the irradiation direction 2x. As a result, the shielded-light portion 44 is shifted from the object when the determined light distribution pattern PTN is radiated to a space in front of the vehicle.

Therefore, the light distribution control apparatus 6 according to the embodiment defines, when the irradiation direction 2x is changed, the shielded-light portion 44 at a position shifted from the position of the shielded-light portion 44 defined based on the correspondence before the change in the irradiation direction 2x by an amount determined by the amount of change in the irradiation direction 2x.

By way of example, the correction unit 28 of the light distribution control apparatus 6 corrects the information on the correspondence based on the amount of change in the irradiation direction 2x at a predetermined point of time and stores the corrected information in the storage medium 18 as the information on the new correspondence.

The predetermined point of time may be at least one of when the ignition switch is switched from off to on, when the vehicle speed exceeds 0, when the shift position is switched from the neutral range to another range (e.g., drive range or first gear), or when the accelerator is switched from off to on. Further, the lamp system 1 of the embodiment is mounted on a rideable saddle vehicle. For this reason, the predetermined point of time may be when the stand ST is switched from the standing position to the stowed position.

The correction unit 28 performs a process to correct the correspondence by receiving a trigger signal indicating that the predetermined point of time has arrived from the ignition switch 30, the vehicle speed sensor 32, the shift sensor 34, the accelerator sensor 36, and the stand sensor 38. The correction unit 28 may perform the correction process each time the detection result is acquired from the irradiation direction sensor 12.

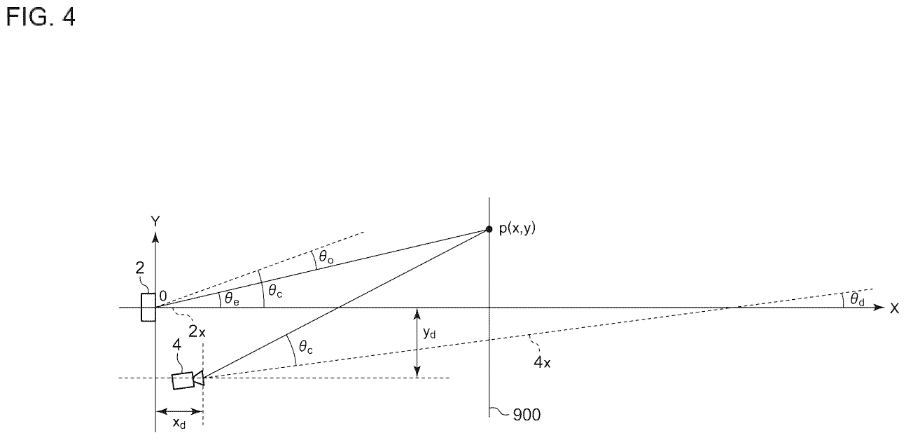

The process to correct the correspondence based on the amount of change in the irradiation direction 2x can be performed as follows. FIG. 4 is a schematic diagram to illustrate a method to correct the correspondence. As shown in FIG. 4, it is assumed, for example, that the variable light distribution lamp 2 and the imaging apparatus 4 are fixed at relative positions such that they are shifted from each other by xa in the X-axis direction and ya in the Y-axis direction. Further, it is assumed that the irradiation direction 2x (aligned with the X-axis) of the variable light distribution lamp 2 and the imaging direction 4x of the imaging apparatus 4 are shifted by an angle θ_{d}. It is assumed that the amounts of shift x_{d}, y_{d} in installation position between the variable light distribution lamp 2 and the imaging apparatus 4 are measured in advance and stored in the storage medium 18.

It is further assumed that there is an object p on a virtual vertical screen 900 distanced from the variable light distribution lamp 2 by a distance x in the X-axis direction. The object p is located at a distance x from the variable light distribution lamp 2 in the X-axis direction and a distance y from the irradiation direction 2x of the light distribution light distribution lamp 2. The angle of the object p as viewed from the variable light distribution lamp 2 is θₑ. The angle of the object p as viewed from the imaging apparatus 4 is θ_{c}. The difference between the angle θₑ and the angle θ_{c} is a parallax shift θₒ between the variable light distribution lamp 2 and the imaging apparatus 4.

The variable light distribution lamp 2 and the imaging apparatus 4 are shifted from each other by x_{d} and y_{d}. Further, the irradiation direction 2x and the imaging direction 4x are shifted by the angle θ_{d}. In this case, the parallax shift θₒ between the variable light distribution lamp 2 and the imaging apparatus 4 can be given by the following expression (1). Expression (1):

θₒ=a tan(y/x)−[a tan {(y−y_{d})/(x−x_{d})}−θ_{d}]

The parallax shift θₒ in the vertical direction between the variable light distribution lamp 2 and the imaging apparatus 4 can be calculated by defining the X-axis direction to be the front-back direction of the variable light distribution lamp 2 and the imaging apparatus 4 and defining the Y-axis direction to be the vertical direction of the variable light distribution lamp 2 and the imaging apparatus 4. Further, the parallax shift θₒ in the horizontal direction between the variable light distribution lamp 2 and the imaging apparatus 4 can be calculated by defining the X-axis direction to be the front-back direction of the variable light distribution lamp 2 and the imaging apparatus 4 and defining the Y-axis direction to be the horizontal direction of the variable light distribution lamp 2 and the imaging apparatus 4.

The mutual correspondence between the irradiation direction 2x and the imaging direction 4x is determined based on the parallax shift θₒ. The correspondence acquired at initial aiming is determined based on the parallax shift θₒ between the irradiation direction 2x and the imaging direction 4x at initial aiming and is stored in the storage medium 18. When the correction unit 28 receives a trigger signal from the ignition switch 30 etc. and detects that the predetermined point of time described above has arrived, the correction unit 28 calculates a shift angle θ_{d} between the irradiation direction 2x and the imaging direction 4x based on the detection result acquired from the irradiation direction sensor 12. The correction unit 28 then calculates the parallax shift θₒ and corrects the information on the correspondence. This allows an amount of change in the irradiation direction 2x to be reflected in the correspondence.

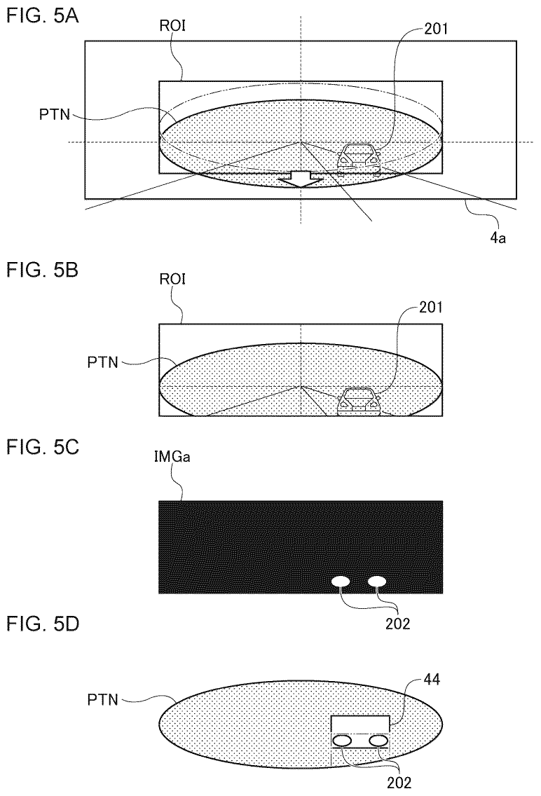

FIG. 5A, FIG. 5B, FIG. 5C, and FIG. 5D illustrate light distribution control that accompanies correction of the correspondence. When the irradiation direction 2x is changed, the relative positions the imaging region 4a and the light distribution pattern PTN changes as shown in FIG. 5A. In this state, the processing region ROI is extracted from the image IMG as shown in FIG. 5B, and the light spot image IMGa is generated as shown in FIG. 5C. Then, as shown in FIG. 5D, the shielded-light portion 44 is set in the region in the light distribution pattern PTN corresponding to the object.

When setting the shielded-light portion 44, the light distribution control apparatus 6 defines the position of the shielded-light portion 44 by using the information on the corrected correspondence. This defines the shielded-light portion 44 at a position (position indicated by the solid line in FIG. 5D) shifted from the position (position indicated by the chain line in FIG. 5D) of the shielded-light portion 44 defined based on the correspondence before the change in the irradiation direction 2x in a direction to cancel out the misalignment between the object and the shielded-light portion 44 by an amount determined by the amount of change in the irradiation direction 2x.

Light distribution control by the light distribution control apparatus 6 of the embodiment is as follows at least temporarily. In other words, the light distribution control apparatus 6 defines the shielded-light portion 44 at the first position in the light distribution pattern PTN when the imaging direction 4x and the irradiation direction 2x are in the first correspondence while the imaging direction 4x is fixed with respect to the object which remains at the same position relative to the vehicle. Meanwhile, the light distribution control apparatus 6 defines the shielded-light portion 44 at the second position in the light distribution pattern PTN shifted from the first position when the imaging direction 4x and the irradiation direction 2x are in the second correspondence different from the first correspondence. When the correspondence between the imaging direction 4x and the irradiation direction 2x is not corrected, the position of the shielded-light portion 44 in the light distribution pattern PTN remains unchanged even if the irradiation direction 2x changes unless the position of the object in the image IMG changes.

The light distribution control apparatus 6 defines the shielded-light portion 44 at the first position in the light distribution pattern PTN when the imaging direction 4x and the irradiation direction 2x are in the first correspondence and the object that remains at the same position relative to the vehicle is at the third position in the imaging region 4a. Further, the light distribution control apparatus 6 also defines the shielded-light portion 44 at the first position in the light distribution pattern PTN when the imaging direction 4x changes due to a change in the vehicle attitude, etc., while the irradiation direction 2x is maintained and the imaging direction 4x and the irradiation direction 2x are placed the second correspondence so that the object is shifted to the fourth position in the imaging region 4a different from the third position. Unless the correspondence between the imaging direction 4x and the irradiation direction 2x is corrected, the position of the shielded-light portion 44 in the light distribution pattern PTN changes when the position of the object in the image IMG changes even if the irradiation direction 2x remains unchanged.

Further, the embodiment covers a computer program executed by the light distribution control apparatus 6. This computer program causes the light distribution control apparatus 6 to execute the function of acquiring the detection result from the irradiation direction sensor 12 that detects the amount of change in the irradiation direction 2x and defining, when the irradiation direction 2x is changed, the shielded-light portion 44 at a position shifted from the position of the shielded-light portion 44 defined based on the pre-change correspondence by an amount determined by the amount of change. Further, the embodiment also covers the storage medium 18 that stores the computer program.

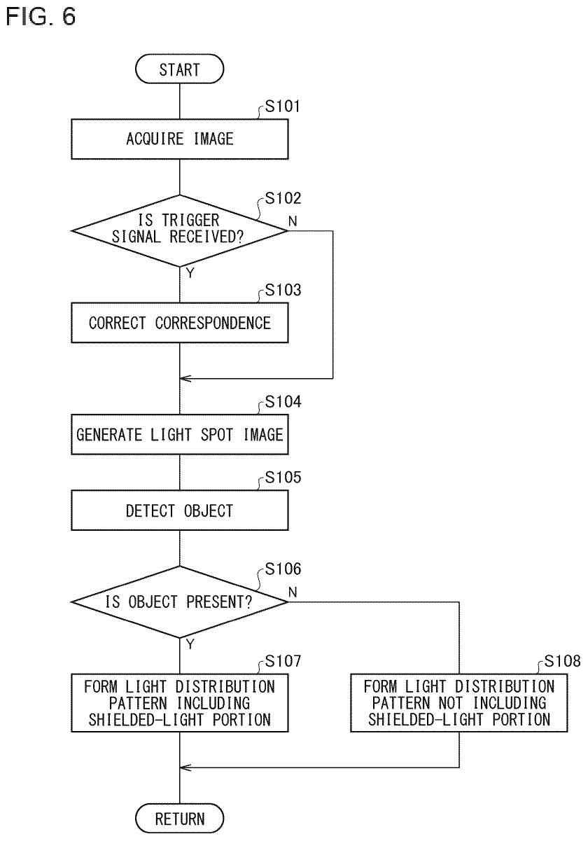

FIG. 6 is a flowchart illustrating an example of control executed by the light distribution control apparatus 6. This flow is repeatedly executed at given points of time when, for example, execution of ADB control is requested via a light switch (not shown) and when the ignition is turned on.

First, the light distribution control apparatus 6 acquires the image IMG from the imaging apparatus 4 (S101). The light distribution control apparatus 6 then determines whether a trigger signal has been received (S102). When a trigger signal is received (Y in S102), the light distribution control apparatus 6 corrects the information on the correspondence stored in the storage medium 18 (S103). When a trigger signal is not received (N in S102), the light distribution control apparatus 6 proceeds to step S104 without correcting the information on the correspondence.

Subsequently, the light distribution control apparatus 6 extracts the processing region ROI from the image IMG and generates the light spot image IMGa from the processing region ROI (S104). The light distribution control apparatus 6 performs an object detection process by using the light spot image IMGa thus generated (S105). Then, the light distribution control apparatus 6 determines whether an object is present (S106) from the result of the object detection process. When an object is present (Y in S106), the light distribution control apparatus 6 controls the variable light distribution lamp 2 (S107) to form the light distribution pattern PTN that includes the shielded-light portion 44 and terminates the routine. When no objects are present (N in S106), the light distribution control apparatus 6 controls the variable light distribution lamp 2 (S108) to form the light distribution pattern PTN that does not include the shielded-light portion 44 and terminates the routine.

As explained above, the light distribution control apparatus 6 according to the embodiment defines, when the irradiation direction 2x of the variable light distribution lamp 2 is changed, the shielded-light portion 44 at a position shifted by an amount determined by the amount of change from the position of the shielded-light portion 44 that would have been defined if the irradiation direction 2x and the imaging direction 4x were in the pre-change correspondence. In this way, the shift between the object and the shielded-light portion 44 can be suppressed by correcting the position of the shielded-light portion 44 according to the amount of change in the irradiation direction 2x. As a result, it is possible to form the shielded-light portion 44 with high precision and increase the accuracy of ADB control even when the variable light distribution lamp 2 and the imaging apparatus 4 are mounted on separate brackets.

Further, the light distribution control apparatus 6 stores the information on the correspondence in the storage medium 18 and corrects the information on the correspondence to cause the amount of change in the irradiation direction 2x to be reflected in the correspondence at a point of time determined based on at least one of the conditions of the ignition switch, vehicle speed, shift position, accelerator, and stand ST. The point of time mentioned above is likely to be immediately after the irradiation direction 2x is changed. Therefore, it is possible to execute highly accurate ADB control more properly while inhibiting the process of correcting the correspondence from being executed wastefully.

### Embodiment 2

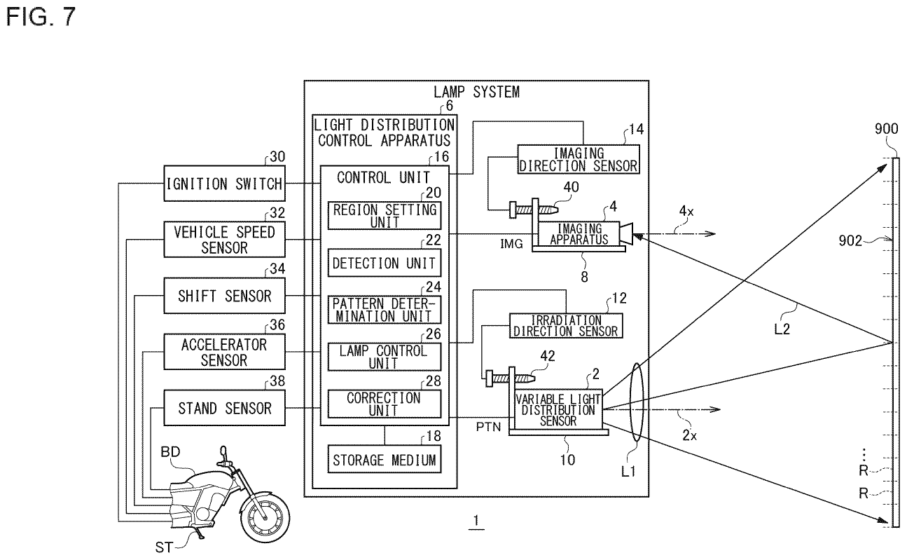

The lamp system 1 according to the embodiment differs from that of embodiment 1 in that the imaging direction 4x is displaceable. The following description of the lamp system 1 according to the embodiment highlights features different from those of embodiment 1. Common features will be briefly explained, or a description thereof is omitted. FIG. 7 is a block diagram of the lamp system 1 according to embodiment 2. FIG. 7 depicts constituting elements of the lamp system 1 as functional blocks, as in FIG. 1.

The lamp system 1 of the embodiment is equipped with a first aiming screw 40 and an imaging direction sensor 14 in addition to the features provided in the lamp system 1 according to embodiment 1. By rotating the first aiming screw 40, the attitude of the first bracket 8 can be changed vertically and horizontally so that the imaging direction 4x of the imaging apparatus 4 can be changed vertically and horizontally. In other words, the first bracket 8 of the embodiment supports the imaging apparatus 4 such that the imaging direction 4x is variable. Further, the first bracket 8 is displaceable independently with respect to the second bracket 10.

The imaging direction sensor 14 is capable of detecting the amount of change (amount of angular change) in the imaging direction 4x. The imaging direction sensor 14 may be placed in the lamp chamber or outside the lamp chamber. The imaging direction sensor 14 includes, for example, a publicly known potentiometer and can detect the amount of change in the imaging direction 4x by referring to the amount of rotation (rotation angle) of the first aiming screw 40. The imaging direction sensor 14 sends a signal indicating a detection result to the control unit 16. The imaging direction sensor 14 may send the amount of rotation of the first aiming screw 40 itself (voltage determined by the amount of rotation) to the control unit 16 as information indicating the amount of change in the imaging direction 4x.

The structure and method of changing the imaging direction 4x are not limited to those using the first aiming screw 40, and other publicly known structures and methods can be adopted. Further, the method of detecting the amount of change by the imaging direction sensor 14 can be selected as appropriate according to the structure and method of changing the imaging direction 4x.

The light distribution control apparatus 6 defines, when at least one of the irradiation direction 2x or the imaging direction 4x is changed, the shielded-light portion 44 at a position shifted from the position of the shielded-light portion 44 defined based on the pre-change correspondence by an amount determined by the amount of change in the irradiation direction 2x and the amount of change in the imaging direction 4x. In the case the irradiation direction 2x and the imaging direction 4x are displaced in a direction away from each other, the amount determined by the amounts of change is a sum of the amounts of change (absolute values). In the case the irradiation direction 2x and the imaging direction 4x are displaced in a direction approaching each other, on the other hand, the amount determined by the amounts of change is a difference between the amounts of change (absolute values). In this way, the position of the shielded-light portion 44 can be corrected according to the amounts of change and the shielded-light portion 44 can be formed with high precision even in a configuration in which both the irradiation direction 2x and the imaging direction 4x can be changed.

The embodiment of the present disclosure has been described above in detail. The embodiment described above is merely a specific example of practicing the present disclosure. The details of the embodiments shall not be construed as limiting the technical scope of the present disclosure. A number of design modifications such as modification, addition, deletion, etc. of constituting elements may be made to the extent that they do not depart from the idea of the invention defined by the claims. New embodiments with design modifications will provide the combined advantages of the embodiment and the variation. Although the details subject to such design modification are emphasized in the embodiment by using phrases such as “of the embodiment” and “in the embodiment”, details not referred to as such are also subject to design modification. Any combination of the above constituting elements is also useful as an embodiment of the present disclosure. Hatching in the cross section in the drawings should not be construed as limiting the material of the hatched object.

The inventions according to embodiments 1, 2 described above may be defined by the items described below.

### Item 1

A lamp system (1) including:
an imaging apparatus (4) that images a scene in front of a vehicle;
a variable light distribution lamp (2) capable of forming a light distribution pattern (PTN) having a shielded-light portion (44);
a first bracket (8) that supports the imaging apparatus (4);
a second bracket (10) that supports the variable light distribution lamp (2) such that an irradiation direction (2x) is variable and that is independently displaceable with respect to the first bracket (8);
an irradiation direction sensor (12) that detects an amount of change in the irradiation direction (2x); and
a light distribution control apparatus (6) that detects an object by using an image (IMG) based on the imaging apparatus (4), defines a position of the shielded-light portion (44) corresponding to the object based on a mutual correspondence between an imaging direction (4x) of the imaging apparatus (4) and the irradiation direction (2x), and controls the variable light distribution lamp (2) to form the light distribution pattern (PTN) having the shielded-light portion (44),
wherein the light distribution control apparatus (6) defines, when the irradiation direction (2x) is changed, the shielded-light portion (44) at a position shifted from the position of the shielded-light portion (44) defined based on a pre-change correspondence by an amount determined by the amount of change.

### Item 2

The lamp system (1) according to Item 1,
wherein the light distribution control apparatus (6):
stores information on the correspondence,
corrects the information based on the amount of change at a predetermined point of time, which is at least one of when an ignition switch is switched from off to on, when a vehicle speed exceeds 0, when a shift position is switched from a neutral range to another range, or when an accelerator is switched from off to on, and
defines the position of the shielded-light portion (44) by using corrected information.

### Item 3

The lamp system according to Item 1 or Item 2,
wherein the lamp system (1) is mounted on a rideable saddle vehicle including a stand (ST) that supports a vehicle body (BD), and
wherein the light distribution control apparatus (6): stores information on the correspondence,
corrects the information based on the amount of change when the stand (ST) is switched from a standing position to a stowed position, and
defines the position of the shielded-light portion (44) by using corrected information.

### Item 4

The lamp system according to any one of Item 1 through Item 3,
wherein the first bracket (8) supports the imaging apparatus (4) such that the imaging direction (4x) is variable, and the first bracket (8) is displaceable independently with respect to the second bracket (10),
wherein the lamp system (1) includes an imaging direction sensor (14) that detects an amount of change in the imaging direction (4x), and
wherein the light distribution control apparatus (6) defines, when at least one of the irradiation direction (2x) or the imaging direction (4x) is changed, the shielded-light portion (44) at a position shifted from a position of the shielded-light portion (44) defined based on a pre-change correspondence by an amount determined by an amount of change in the irradiation direction (2x) and an amount of change in the imaging direction (4x).

### Item 5

A light distribution control apparatus (6) that detects an object by using an image (IMG) based on an imaging apparatus (4) that images a scene in front of a vehicle, defines a position of a shielded-light portion (44) corresponding to the object based on a mutual correspondence between an imaging direction (4x) of the imaging apparatus (4) and an irradiation direction (2x) of a variable light distribution lamp (2), and controls the variable light distribution lamp (2) to form a light distribution pattern (PTN) having the shielded-light portion (44),
wherein the light distribution control apparatus (6):
acquires a detection result from an irradiation direction sensor (12) that detects an amount of change in the irradiation direction (2x), and
defines, when the irradiation direction (2x) is changed, the shielded-light portion (44) at a position shifted from the position of the shielded-light portion (44) defined based on a pre-change correspondence by an amount determined by the amount of change.

### Item 6

A light distribution control apparatus (6) that detects an object by using an image (IMG) based on an imaging apparatus (4) that images a scene in front of a vehicle, defines a position of a shielded-light portion (4) corresponding to the object based on a mutual correspondence between an imaging direction (4x) of the imaging apparatus (4) and an irradiation direction (2x) of a variable light distribution lamp (2), and controls the variable light distribution lamp (2) to form a light distribution pattern (PTN) having the shielded-light portion (44),
wherein, while the imaging direction (4x) is fixed with respect to the object which remains at the same position relative to the vehicle,
the light distribution control apparatus (6) defines the shielded-light portion (44) at a first position in the light distribution pattern (PTN) when the imaging direction (4x) and the irradiation direction (2x) are in a first correspondence and defines the shielded-light portion (44) at a second position in the light distribution pattern (PTN) shifted from the first position when the imaging direction (4x) and the irradiation direction (2x) are in a second correspondence different from the first correspondence.

### Item 7

A computer program executed by a light distribution control apparatus (6) that detects an object by using an image (IMG) based on an imaging apparatus (4) that images a scene in front of a vehicle, defines a position of a shielded-light portion (44) corresponding to the object based on a mutual correspondence between an imaging direction (4x) of the imaging apparatus (4) and an irradiation direction (2x) of a variable light distribution lamp (2), and controls the variable light distribution lamp (2) to form a light distribution pattern (PTN) having the shielded-light portion (44),
wherein the computer program causes the light distribution control apparatus (6) to execute a function of acquiring a detection result from an irradiation direction sensor (12) that detects an amount of change in the irradiation direction (2x) and defining, when the irradiation direction (2x) is changed, the shielded-light portion (44) at a position shifted from the position of the shielded-light portion (44) defined based on a pre-change correspondence by an amount determined by the amount of change.

### Embodiment 3

FIG. 1 is a block diagram of a lamp system 1 according to embodiment 3. FIG. 1 depicts the constituting elements of the lamp system 1 as functional blocks. The functional blocks are implemented in hardware such as devices and circuits exemplified by a CPU and a memory of a computer, and in software such as a computer program. It will be understood by those skilled in the art that these functional blocks may be implemented in a variety of forms by combinations of hardware and software.

The lamp system 1 is equipped with a variable light distribution lamp 2, an imaging apparatus 4, a light distribution control apparatus 6, a first bracket 8, a second bracket 10, and an irradiation direction sensor 12. These are mounted on the vehicle. In the embodiment, the vehicle equipped with the lamp system 1 is a rideable saddle vehicle such as a motorcycle by way of example.

The mechanisms including the variable light distribution lamp 2, the imaging apparatus 4, the light distribution control apparatus 6, the first bracket 8, the second bracket 10, and the irradiation direction sensor 12 mentioned above may all be built into the same housing, or several mechanisms may be provided outside the housing. For example, the mechanisms are housed in a lamp chamber. The lamp chamber is defined by a lamp body having an opening on the frontward side of the vehicle and a translucent cover attached to cover the opening of the lamp body.

The imaging apparatus 4, the light distribution control apparatus 6, the first bracket 8, and the irradiation direction sensor 12 may be provided outside the lamp chamber (e.g., on the vehicle side). In this case, the imaging apparatus 4 may be a vehicle-mounted camera. In the case the imaging apparatus 4 is a vehicle-mounted camera, a vehicle body BD may represent the first bracket 8. Further, the light distribution control apparatus 6 may, for example, be comprised of a vehicle ECU entirely or in part.

The variable light distribution lamp 2 is capable of radiating a variable intensity distribution visible light beam L1 to a region in front of the driver's vehicle. The variable light distribution lamp 2 can individually vary that illuminance of light irradiating a plurality of individual regions R arranged in the region in front. In other words, the variable light distribution lamp 2 can irradiate the space in front of the driver's vehicle with a light having an illuminance that varies depending on the location (individual region R). The plurality of individual regions R may, for example, be arranged in a row in the vehicle width direction or arranged in a matrix. The variable light distribution lamp 2 receives information designating the light distribution pattern PTN from the light distribution control apparatus 6 and outputs the visible light beam L1 having an intensity distribution determined by the light distribution pattern PTN. Thereby, the light distribution pattern PTN is formed in front of the vehicle. The light distribution pattern PTN is understood to be a two-dimensional illuminance distribution of an irradiation pattern 902 that the variable light distribution lamp 2 forms on a vertical virtual screen 900 in front of the driver's vehicle.

The embodiment is non-limiting as to the configuration of the variable light distribution lamp 2. For example, the variable light distribution lamp 2 includes a plurality of light sources arranged in a horizontal row or in a matrix and a lighting circuit that drives the light sources individually to light the light sources. Preferable examples of the light source include a semiconductor light source such as a LED (light emitting device), a LD (laser diode), and an organic or inorganic EL (electroluminescence). Each individual region R and each light source are associated with each other, and each individual region R is individually irradiated with a light from each light source. The resolution of the variable light distribution lamp 2, i.e., the light distribution resolution, is about 4 pixels-20 pixels in the case the light sources are arranged in a horizontal row and about 1000-2000000 pixels in the case the light sources are arranged in a matrix. The resolution of the variable light distribution lamp 2 means the number of unit regions in the light distribution pattern PTN for which the illuminance can be varied independently.

For formation of an illuminance distribution determined by the light distribution pattern PTN, the variable light distribution lamp 2 may include a pattern formation device of matrix type such as a DMD (Digital Mirror Device) and a liquid crystal device or include a pattern formation device of optical scan type configured to scan a scene in front of the driver's vehicle with a light from the light source. The variable light distribution lamp 2 may alternatively be a configured to partially block light irradiation of the region in front by using a shade plate.

The imaging apparatus 4 is exemplified by a camera, has sensitivity in the visible light zone, and images a scene in front of the driver's vehicle repeatedly. The imaging apparatus 4 images a reflected light L2 from an object in front of the vehicle reflecting the visible light beam L1. Further, the imaging apparatus 4 images a light radiated by vehicles in front, which include leading vehicles and oncoming vehicles, and a light radiated by a self-luminous body such as a streetlight and an electronic message board. An image IMG generated by the imaging apparatus 4 is sent to the light distribution control apparatus 6.

The image IMG acquired by the light distribution control apparatus 6 from the imaging apparatus 4 may be RAW image data or image data subjected to a predetermined image process by the imaging apparatus 4. Reception by the light distribution control apparatus 6 of image data derived from subjecting the RAW image data generated by the imaging apparatus 4 to an image process by a processing apparatus other than the imaging apparatus 4 also represents acquisition of the image IMG from the imaging apparatus 4. In the following description, “the image IMG based on the imaging apparatus 4” means whichever of RAW image data and data subjected to an image process. Both of the image data may be expressed as “image IMG” without making any distinction therebetween.

The light distribution control apparatus 6 detects an object by using the image IMG based on the imaging apparatus 4 and controls the variable light distribution lamp 2 to form the light distribution pattern PTN having a shielded-light portion corresponding to the detected object. In other words, the light distribution control apparatus 6 performs ADB control for dynamically and adaptively control the light distribution of the variable light distribution lamp 2 in accordance with an object located in the region in front. The light distribution control apparatus 6 of the embodiment detects a vehicle in front as an object. The light distribution control apparatus 6 may detect an object other than the vehicle in front. In the embodiment, the fact that the shielded-light portion “corresponds to the object” means that the shielded-light portion overlaps the object when the light distribution pattern PTN is projected forward. The light distribution control apparatus 6 sends information designating the light distribution pattern PTN to the variable light distribution lamp 2.

The light distribution control apparatus 6 may be comprised of a digital processor. For example, the light distribution control apparatus 6 may be comprised of a combination of a microcomputer, including a CPU, and a software program. The light distribution control apparatus 6 may alternatively be comprised of a FPGA (Field Programmable Gate Array), an ASIC (Application Specified IC), or the like.

The light distribution control apparatus 6 includes a control unit 16 comprised of a CPU, etc., and a storage medium 18 comprised of a memory or a storage. The control unit 16 includes a region setting unit 20, a detection unit 22, a pattern determination unit 24, a lamp control unit 26, and a correction unit 28 by way of example. The storage medium 18 stores a computer program executed by the light distribution control apparatus 6 (more specifically, the control unit 16) and information on correspondence described later. Each part included in the control unit 16 operates by executing, in the integrated circuit constituting the part, a program stored in the storage medium 18. The operation of each part will be explained later.

The control unit 16 can also receive signals sent from an ignition switch 30, a vehicle speed sensor 32, a shift sensor 34, an accelerator sensor 36, and a stand sensor 38 mounted on the vehicle. The ignition switch 30 transmits a signal indicating on/off of ignition to the control unit 16. The vehicle speed sensor 32 transmits a signal indicating the vehicle speed to the control unit 16. The shift sensor 34 transmits a signal indicating the shift position to the control unit 16. The accelerator sensor 36 transmits a signal indicating the accelerator operation amount of the driver to the control unit 16. The stand sensor 38 transmits a signal indicating whether a stand ST supporting the vehicle body BD is in the standing position or the stowed position to the control unit 16. The lamp system 1 may be mounted on a vehicle such as a four-wheeled vehicle other than a rideable saddle vehicle. In this case, the vehicle is not equipped with a stand ST or a stand sensor 38.

The first bracket 8 supports the imaging apparatus 4. The first bracket 8 of the embodiment supports the imaging apparatus 4 such that an imaging direction 4x is immovable. The first bracket 8 has a publicly known structure. The “imaging direction 4x” of the imaging apparatus 4 can be translated into the “angle of the imaging axis” or “orientation” of the imaging apparatus 4.

The second bracket 10 supports the variable light distribution lamp 2 such that an irradiation direction 2x is variable. The second bracket 10 has a publicly known structure. The second bracket 10 by way of example has a second aiming screw 42. By rotating the second aiming screw 42, the attitude of the second bracket 10 can be changed upward, downward, leftward, or rightward so that the irradiation direction 2x of the variable light distribution lamp 2 can be tilted upward, downward, leftward, or rightward. The “irradiation direction 2x” of the variable light distribution lamp 2 can be translated into the “angle of the optical axis” or “orientation” of the variable light distribution lamp 2.

The second bracket 10 is independently displaceable with respect to the first bracket 8. Therefore, the correspondence between the imaging direction 4x and the irradiation direction 2x could change from the state set in initial aiming carried out at a vehicle manufacturer's manufacturing plant or a dealer's maintenance shop due to the displacement of the second bracket 10 that could occur during the use of the vehicle.

The irradiation direction sensor 12 can detect the amount of change (amount of angular change) in the irradiation direction 2x of the variable light distribution lamp 2. The irradiation direction sensor 12 includes, for example, a known potentiometer and can detect the amount of change in the irradiation direction 2x by referring to the amount of rotation (rotation angle) of the second aiming screw 42. The irradiation direction sensor 12 sends a signal indicating a detection result to the control unit 16. The irradiation direction sensor 12 may send the amount of rotation (voltage determined by the amount of rotation) of the second aiming screw 42 itself to the control unit 16 as information indicating the amount of change in the irradiation direction 2x.

The structure and method of changing the irradiation direction 2x are not limited to those using the second aiming screw 42, but other publicly known structures and methods may be adopted. Further, the method of detecting the amount of change by the irradiation direction sensor 12 can be selected as appropriate in accordance with the structure and method of changing the irradiation direction 2x.

A description will now be given of the operation of the light distribution control apparatus 6. FIG. 2A, FIG. 2B, FIG. 2C, and FIG. 2D illustrate the basic operation of light distribution control. FIG. 2A shows an imaging region 4a of the imaging apparatus 4 and the light distribution pattern PTN formed in front of the vehicle. A light distribution pattern for high beam is shown as an example of the light distribution pattern PTN. FIG. 2A illustrates a processing region ROI set in the image IMG (in other words, the imaging region 4a) for convenience. Further, the following description uses an oncoming car 201 as an example of an object.

When the oncoming vehicle 201 is present in front of the vehicle, the image IMG including the oncoming vehicle 201 is generated by the imaging apparatus 4 and sent to the light distribution control apparatus 6. The image IMG sent to the light distribution control apparatus 6 is acquired by the region setting unit 20. The region setting unit 20 sets the processing region ROI in the image IMG. The processing region ROI is set based on the correspondence between the imaging direction 4x and the irradiation direction 2x. Information on this correspondence links position coordinates in the image IMG and position coordinates in the light distribution pattern PTN and is, for example, created at initial aiming and stored in the storage medium 18.

The position where the processing region ROI should be set and the shape of the processing region ROI can be determined in advance based on an experiment or a simulation by the designer. For example, the processing region ROI is set to be a range in the image IMG that overlaps the irradiation range of the light distribution pattern PTN. The range in the image IMG that overlaps the irradiation range of the light distribution pattern PTN is identified based on the correspondence described above. Information on the processing region ROI includes position coordinates in the image IMG and is stored in the storage medium 18 in advance. The image IMG for which the processing region ROI is set is sent to the detection section 22.

The detection unit 22 extracts the processing region ROI from the image IMG as shown in FIG. 2B. The detection unit 22 then subjects the processing region ROI to a publicly known image process such as a binarization process. This generates, as shown in FIG. 2C, a light spot image IMGa in which two light spots 202 corresponding to the lamps of the oncoming vehicle 201 are extracted. The lamps of the oncoming car 201 are headlamps, etc. In the case the target of detection is a leading vehicle, the light spots 202 corresponding to the rear lamps, etc. of the leading vehicle will be included in the light spot image IMGa. The rear lamps include stop lamps and tail lamps.

The detection unit 22 determines the presence or absence of an object by using the light spot image IMGa. Execution of an object detection process in the light spot image IMGa corresponds to execution of an object detection process in the image IMG or the processing region ROI. The detection unit 22 detects the object based on the light spot 202 when the light spot 202 is included in the light spot image IMGa. For example, the detection unit 22 determines that the light spot 202 present in the processing region ROI originates from the object, i.e., determines that the object is present at the location where the light spot 202 is present.

The detection unit 22 sends a detection result to the pattern determination unit 24. Further, the target detection method carried out by the detection unit 22 is not particularly limited. For example, generation of a light spot image IMGa may be omitted, and the object may be detected from the processing region ROI by using a publicly known method including algorithm recognition and deep learning. Further, the type of object (vehicle in front, oncoming vehicle 201, leading vehicle, sign, etc.) may or may not be identified. The detection unit 22 can identify the type of object by algorithm recognition or deep learning described above or based on a publicly known indicator for judgment such as the position of the light spot 202 and pairing of the light spots 202.

When an object is detected, the pattern determination unit 24 sets a shielded-light portion 44 in a region in the base light distribution pattern corresponding to the object, as shown in FIG. 2D. This determines the light distribution pattern PTN that should be formed. The shielded-light portion 44 is a portion in the light distribution pattern PTN where the brightness (illuminance) is 0 or a portion where the brightness exceeds 0 but is lower than the pre-shading brightness. When no objects are detected, the pattern determination unit 24 defines the light distribution pattern PTN without the shielded-light portion 44.

The base light distribution pattern is selected according to the light distribution mode determined based on the driver's instruction (e.g., the manipulation of a light switch (not shown)), the traveling condition of the driver's vehicle, and the environment around the vehicle. For example, light distribution modes include a high beam mode for forming a light distribution pattern for high beam, a low beam mode for forming a light distribution pattern for low beam, and a town mode for forming a light distribution pattern suitable for urban driving. FIG. 2D shows a light distribution pattern for high beam by way of example.

The position of the shielded-light portion 44 is defined based on the correspondence between the imaging direction 4x and the irradiation direction 2x. Based on this correspondence, the position of the shielded-light portion 44 in the light distribution pattern PTN can be defined according to the position of the object in the light spot image IMGa. By way of example, the pattern determination unit 24 defines the shielded-light portion 44 of a predetermined shape in the light distribution pattern PTN. The pattern determination part 24 may deform the shape of the light spot 202 by applying a publicly known expansion and compression process to the light spot image IMGa and may define the deformed shape of the light spot 202 as the shape of the shielded-light portion 44. The pattern determination unit 24 sends the information on the light distribution pattern PTN thus determined to the lamp control unit 26.

The lamp control unit 26 directs the variable light distribution lamp 2 to form the light distribution pattern PTN. The lamp control unit 26 is comprised of, for example, a publicly known LED driver module (LDM). In the case the dimming method of the light source of the variable light distribution lamp 2 is analog dimming, the lamp control unit 26 adjusts the DC level of the driving current flowing in the light source. Further, in the case the dimming method of the light source is PWM (Pulse Width Modulation) dimming, the lamp control unit 26 adjusts the average level of the driving current by switching the current flowing in the light source and adjusting the ratio of the on period. Further, in the case the variable light distribution lamp 2 has a DMD, the lamp control unit 26 controls on/off switching of each mirror element constituting the DMD. In the case the variable light distribution lamp 2 includes a liquid crystal device, the lamp control unit 26 controls the light transmittance of the liquid crystal device. This forms the light distribution pattern PTN in front of the vehicle.

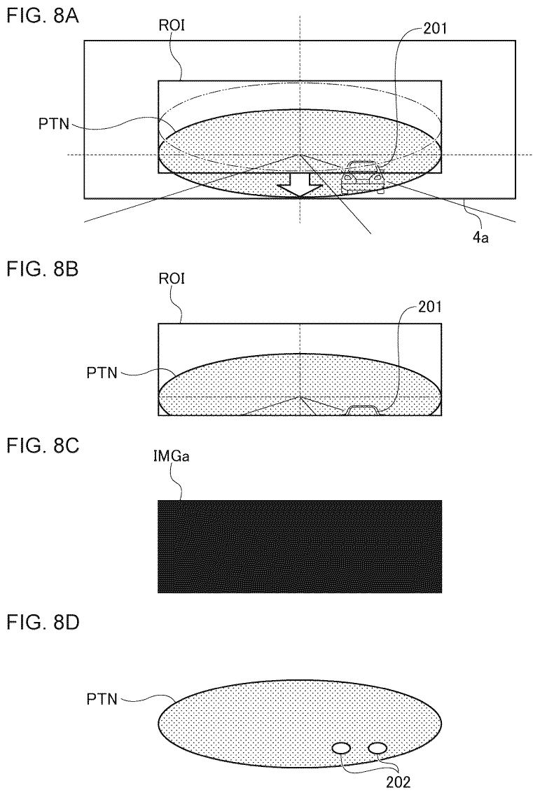

A description will now be given of position correction of the processing region ROI performed when the mutual correspondence between the irradiation direction 2x and the imaging direction 4x changes from that of initial aiming. FIG. 8A, FIG. 8B, FIG. 8C, and FIG. 8D show a case in which the basic operation is performed in a situation where the mutual correspondence between the irradiation direction 2x and the imaging direction 4x changes from that of initial aiming.

As described above, the light distribution control apparatus 6 defines the processing region ROI in the image IMG based on the mutual correspondence between the imaging direction 4x and the irradiation direction 2x. In such control, a situation could occur in which the processing region ROI and the irradiation range of the light distribution pattern PTN are misaligned and the shielded-light portion 44 cannot be superimposed on the object when the light distribution pattern PTN is radiated, if the correspondence changes from what was acquired at initial aiming.

For example, auto-leveling function has been put into practical use for adjustment of the irradiation direction 2x. In this case, the attitude of the second bracket 10 is automatically changed by the auto-leveling function before the vehicle starts running if the vehicle attitude changes due to the load. This allows the irradiation direction 2x to be adjusted to an angle suited to the vehicle attitude. Alternatively, the irradiation direction 2x may be changed manually.

When the variable light distribution lamp 2 and the imaging apparatus 4 are mounted on the same bracket, it is possible to change the irradiation direction 2x while maintaining the correspondence between the irradiation direction 2x and the imaging direction 4x at initial aiming. If it is attempted to mount the variable light distribution lamp 2 and the imaging apparatus 4 on the same bracket, however, the bracket may have to have a larger size and the place where the bracket can be installed could be limited. In this case, the flexibility of arrangement of the variable light distribution lamp 2 and the imaging apparatus 4 is reduced. For this reason, it is desirable to mount the variable light distribution lamp 2 and the imaging apparatus 4 on separate brackets as in the embodiment.

When the variable light distribution lamp 2 and the imaging apparatus 4 are mounted on separate brackets, the imaging direction 4x is often fixed as in the embodiment. One of the reasons for this is that the imaging range of the imaging apparatus 4 is generally wider than irradiation range of the variable light distribution lamp 2, and the entire light distribution pattern PTN after the displacement of the irradiation direction 2x can be imaged even if the imaging direction 4x is fixed. When the variable light distribution lamp 2 and the imaging apparatus 4 are mounted on separate brackets, therefore, the mutual correspondence between the irradiation direction 2x and the imaging direction 4x could change from that of initial aiming.

When the irradiation direction 2x is changed, the relative positions of the imaging region 4a and the light distribution pattern PTN changes, as shown in FIG. 8A. In this state, the processing region ROI is set in the image IMG. In the basic operation, the processing region ROI is set in the image IMG based on the correspondence created at initial aiming, and so the processing region ROI is shifted from the light distribution pattern PTN. In this case, the lamp of the oncoming vehicle 201 may be removed from the processing region ROI as shown in FIG. 8B even if the oncoming vehicle 201 is present in the imaging region 4a.

Therefore, the light spot image IMGa that does not include a light spot 202 could be created as shown in FIG. 8C. Vehicle detection using this light spot image IMGa cannot detect the oncoming vehicle 201 even if the oncoming vehicle 201 is actually present. As a result, the light distribution pattern PTN without shielded-light portion 44 is defined as shown in FIG. 8D.

Therefore, the light distribution control apparatus 6 according to the embodiment defines, when the irradiation direction 2x is changed, the processing region ROI at a position shifted from the position of the processing region ROI determined based on the correspondence before the change in the irradiation direction 2x by an amount determined by the amount of change in the irradiation direction 2x.

By way of example, the correction unit 28 of the light distribution control apparatus 6 corrects the information on the correspondence based on the amount of change in the irradiation direction 2x at a predetermined point of time and stores the corrected information in the storage medium 18 as the information on the new correspondence.

The predetermined point of time may be at least one of when the ignition switch is switched from off to on, when the vehicle speed exceeds 0, when the shift position is switched from the neutral range to another range (e.g., drive range or first gear), or when the accelerator is switched from off to on. Further, the lamp system 1 of the embodiment is mounted on a rideable saddle vehicle. For this reason, the predetermined point of time may be when the stand ST is switched from the standing position to the stowed position.

The correction unit 28 performs a process to correct the correspondence by receiving a trigger signal indicating that the predetermined point of time has arrived from the ignition switch 30, the vehicle speed sensor 32, the shift sensor 34, the accelerator sensor 36, and the stand sensor 38. The correction unit 28 may perform the correction process each time the detection result is acquired from the irradiation direction sensor 12.

The process to correct the correspondence based on the amount of change in the irradiation direction 2x can be performed as follows. FIG. 4 is a schematic diagram to illustrate a method to correct the correspondence. As shown in FIG. 4, it is assumed, for example, that the variable light distribution lamp 2 and the imaging apparatus 4 are fixed at positions such that they are shifted from each other by xa in the X-axis direction and ya in the Y-axis direction. Further, it is assumed that the irradiation direction 2x (aligned with the X-axis) of the variable light distribution lamp 2 and the imaging direction 4x of the imaging apparatus 4 are shifted by an angle θ_{d}. The amounts of shift x_{d}, y_{d} in installation position between the variable light distribution lamp 2 and the imaging apparatus 4 are measured in advance and stored in the storage medium 18.

It is assumed that there is an object p on a virtual vertical screen 900 distanced from the variable light distribution lamp 2 by a distance x in the X-axis direction. The object p is located at a distance x from the variable light distribution lamp 2 in the X-axis direction and a distance y from the irradiation direction 2x of the light distribution light distribution lamp 2. The angle of the object p as viewed from the variable light distribution lamp 2 is θₑ. The angle of the object p as viewed from the imaging apparatus 4 is θ_{c}. The difference between the angle θₑ and the angle θ_{c} is a parallax shift θₒ between the variable light distribution lamp 2 and the imaging apparatus 4.

The variable light distribution lamp 2 and the imaging apparatus 4 are shifted from each other by x_{d} and y_{d}. Further, the irradiation direction 2x and the imaging direction 4x are shifted by the angle θ_{d}. In this case, the parallax shift θₒ between the variable light distribution lamp 2 and the imaging apparatus 4 can be given by the following expression (1).

$${θ}_{O} = atan ( y / x ) = [ atan \{ ( y - {y}_{d} ) / ( x - {x}_{d} ) \} - {θ}_{d} ] \qquad Expression ( 1 )$$

The parallax shift θₒ in the vertical direction between the variable light distribution lamp 2 and the imaging apparatus 4 can be calculated by defining the X-axis direction to be the front-back direction of the variable light distribution lamp 2 and the imaging apparatus 4 and defining the Y-axis direction to be the vertical direction of the variable light distribution lamp 2 and the imaging apparatus 4. Further, the parallax shift θₒ in the horizontal direction between the variable light distribution lamp 2 and the imaging apparatus 4 can be calculated by defining the X-axis direction to be the front-back direction of the variable light distribution lamp 2 and the imaging apparatus 4 and defining the Y-axis direction to be the horizontal direction of the variable light distribution lamp 2 and the imaging apparatus 4.

The mutual correspondence between the irradiation direction 2x and the imaging direction 4x is determined based on the parallax shift θₒ. The correspondence acquired at initial aiming is determined based on the parallax shift θₒ between the irradiation direction 2x and the imaging direction 4x at initial aiming and is stored in the storage medium 18. When the correction unit 28 receives a trigger signal from the ignition switch 30 etc. and detects that the predetermined point of time described above has arrived, the correction unit 28 calculates a shift angle θ_{d} between the irradiation direction 2x and the imaging direction 4x based on the detection result acquired from the irradiation direction sensor 12. Then, the parallax shift θₒ is calculated to correct the information on the correspondence. This allows an amount of change in the irradiation direction 2x to be reflected in the correspondence.

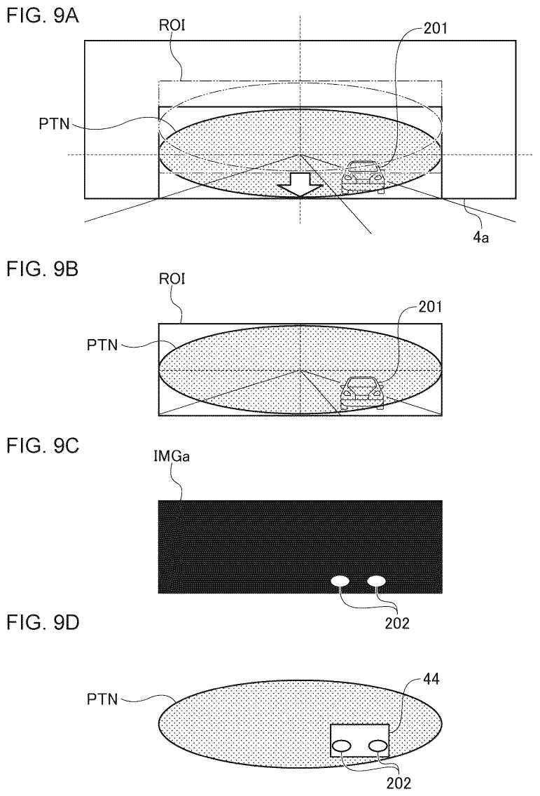

FIG. 9A, FIG. 9B, FIG. 9C, and FIG. 9D illustrate light distribution control that accompanies correction of the correspondence. When the irradiation direction 2x is changed, the relative positions the imaging region 4a and the light distribution pattern PTN changes as shown in FIG. 9A. In this state, the processing region ROI is set. Then, the processing region ROI is extracted from the image IMG as shown in as shown in FIG. 9B. When setting the processing region ROI, the light distribution control apparatus 6 defines the position of the processing region ROI by using the information on the corrected correspondence. This defines the processing region ROI at a position (position indicated by the solid line in FIG. 9A) shifted from the position (position indicated by the chain line in FIG. 9A) of the processing region ROI defined based on the correspondence before the change in the irradiation direction 2x in a direction to cancel out the misalignment between the processing region ROI and the light distribution pattern PTN by an amount determined by the amount of change in the irradiation direction 2x.

Therefore, the light spot image IMGa generated from this processing region ROI can include two light spots 202 corresponding to the lamps of the oncoming vehicle 201 as shown in FIG. 9C. As a result, the light distribution pattern PTN including the shielded-light portion 44 overlapping the oncoming vehicle 201 can be formed in front of the vehicle as shown in FIG. 9D. By way of example, the pattern determination unit 24 defines the shielded-light portion 44 in the light distribution pattern PTN based on the information on the corrected correspondence.

Light distribution control by the light distribution control apparatus 6 of the embodiment is as follows at least temporarily. In other words, the light distribution control apparatus 6 defines the shielded-light portion 44 in the light distribution pattern PTN when the imaging direction 4x and the irradiation direction 2x are in the first correspondence while the imaging direction 4x is fixed with respect to the object which remains at the same position relative to the vehicle. Meanwhile, the light distribution control apparatus 6 does not define the shielded-light portion 44 in the light distribution pattern PTN when the imaging direction 4x and the irradiation direction 2x are in the second correspondence different from the first correspondence. The second correspondence is a relationship between the imaging direction 4x and the irradiation direction 2x occurring when, for example, the object is removed from the light distribution pattern PTN. When the correspondence between the imaging direction 4x and the irradiation direction 2x is not corrected, the object will remain positioned in the processing region ROI unless the position of the object in the image IMG changes. Therefore, the shielded-light portion 44 is set in the light distribution pattern PTN even if the irradiation direction 2x changes and the object is removed from the light distribution pattern PTN.

The light distribution control apparatus 6 defines the shielded-light portion 44 in the light distribution pattern PTN when the imaging direction 4x and the irradiation direction 2x are in the first correspondence and the object, which remains at the same position relative to the vehicle, is in the processing region ROI. Further, the light distribution control apparatus 6 also defines the shielded-light portion 44 in the light distribution pattern PTN when the imaging direction 4x changes due to a change in the vehicle attitude, etc. and the object is removed from the processing region ROI in the presence of the first correspondence, while the irradiation direction 2x is maintained and the imaging direction 4x and the irradiation direction 2x are in the second correspondence. When the correspondence between the imaging direction 4x and the irradiation direction 2x is not corrected, the shielded-light portion 44 is not set in the light distribution pattern PTN even if the irradiation direction 2x is not displaced and the object is in the irradiation range of the light distribution pattern PTN, if the imaging direction 4x is displaced and the object is removed from the processing region ROI in the presence of the first correspondence.

Further, the embodiment covers a computer program executed by the light distribution control apparatus 6. This computer program acquires the detection result from the irradiation direction sensor 12 that detects the amount of change in the irradiation direction 2x. When the irradiation direction 2x is changed, the computer program causes the light distribution control apparatus 6 to execute the function of defining the processing region ROI at a position shifted from the position of the processing region ROI defined based on the pre-change correspondence by an amount determined by the amount of change. Further, the embodiment also covers the storage medium 18 that stores the computer program.

FIG. 6 is a flowchart illustrating an example of control executed by the light distribution control apparatus 6. This flow is repeatedly executed at given points of time when, for example, execution of ADB control is requested via a light switch (not shown) and when the ignition is turned on.

First, the light distribution control apparatus 6 acquires the image IMG from the imaging apparatus 4 (S101). The light distribution control apparatus 6 then determines whether a trigger signal has been received (S102). When a trigger signal is received (Y in S102), the light distribution control apparatus 6 corrects the information on the correspondence stored in the storage medium 18 (S103). When a trigger signal is not received (N in S102), the light distribution control apparatus 6 proceeds to step S104 without correcting the information on the correspondence.

Subsequently, the light distribution control apparatus 6 extracts the processing region ROI from the image IMG by using the information on the correspondence and generates the light spot image IMGa from the processing region ROI (S104). The light distribution control apparatus 6 performs an object detection process by using the light spot image IMGa thus generated (S105). Then, the light distribution control apparatus 6 determines whether an object is present (S106) from the result of the object detection process. When an object is present (Y in S106), the light distribution control apparatus 6 controls the variable light distribution lamp 2 (S107) to form the light distribution pattern PTN that includes the shielded-light portion 44 and terminates the routine. When no objects are present (N in S106), the light distribution control apparatus 6 controls the variable light distribution lamp 2 (S108) to form the light distribution pattern PTN that does not include the shielded-light portion 44 and terminates the routine.

As explained above, the light distribution control apparatus 6 according to the embodiment defines, when the irradiation direction 2x is changed, the processing region ROI at a position shifted by an amount determined by the amount of change from the position of the processing region ROI that would have been defined if the irradiation direction 2x and the imaging direction 4x were in the pre-change correspondence. Thus, it is possible, by correcting the position of the processing region ROI in accordance with the amount of change in the irradiation direction 2x, to form the shielded-light portion 44 with high precision even when the variable light distribution lamp 2 and the imaging apparatus 4 are mounted on separate brackets. Therefore, it is possible to increase the accuracy of ADB control.

Further, the light distribution control apparatus 6 stores the information on the correspondence in the storage medium 18 and corrects the information on the correspondence to cause the amount of change in the irradiation direction 2x to be reflected in the correspondence at a point of time determined based on at least one of the conditions of the ignition switch, vehicle speed, shift position, accelerator, and stand ST. The point of time mentioned above is likely to be immediately after the irradiation direction 2x is changed. Therefore, it is possible to execute highly accurate ADB control more properly while inhibiting the process of correcting the correspondence from being executed wastefully.

### Embodiment 4

The lamp system 1 according to the embodiment differs from that of embodiment 3 in that the imaging direction 4x is displaceable. The following description of the lamp system 1 according to the embodiment highlights features different from those of embodiment 3. Common features will be briefly explained, or a description thereof is omitted. FIG. 7 is a block diagram of the lamp system 1 according to embodiment 4. FIG. 7 depicts constituting elements of the lamp system 1 as functional blocks, as in FIG. 1.

The lamp system 1 of the embodiment is equipped with a first aiming screw 40 and an imaging direction sensor 14 in addition to the features provided in the lamp system 1 according to embodiment 3. By rotating the first aiming screw 40, the attitude of the first bracket 8 can be changed vertically and horizontally so that the imaging direction 4x of the imaging apparatus 4 can be changed vertically and horizontally. In other words, the first bracket 8 of the embodiment supports the imaging apparatus 4 such that the imaging direction 4x is variable. Further, the first bracket 8 is displaceable independently with respect to the second bracket 10.

The imaging direction sensor 14 is capable of detecting the amount of change (amount of angular change) in the imaging direction 4x. The imaging direction sensor 14 may be placed in the lamp chamber or outside the lamp chamber. The imaging direction sensor 14 includes, for example, a publicly known potentiometer and can detect the amount of change in the imaging direction 4x by referring to the amount of rotation (rotation angle) of the first aiming screw 40. The imaging direction sensor 14 sends a signal indicating a detection result to the control unit 16. The imaging direction sensor 14 may send the amount of rotation of the first aiming screw 40 itself (voltage determined by the amount of rotation) to the control unit 16 as information indicating the amount of change in the imaging direction 4x.

The structure and method of changing the imaging direction 4x are not limited to those using the first aiming screw 40, but other known structures and methods may be adopted. Further, the method of detecting the amount of change by the imaging direction sensor 14 can be selected as appropriate according to the structure and method of changing the imaging direction 4x.

The light distribution control apparatus 6 defines, when at least one of the irradiation direction 2x or the imaging direction 4x is changed, the processing region ROI at a position shifted from the position of the processing region ROI defined based on the pre-change correspondence by an amount determined by the amount of change in the irradiation direction 2x and the amount of change in the imaging direction 4x. In the case the irradiation direction 2x and the imaging direction 4x are displaced in a direction away from each other, the amount determined by the amounts of change is a sum of the amounts of change (absolute values). In the case the irradiation direction 2x and the imaging direction 4x are displaced in a direction approaching each other, the amount determined by the amounts of change is a difference between the amounts of change (absolute values). In this way, the position of the processing region ROI can be corrected according to the amounts of change and the shielded-light portion 44 can be formed with high precision even in a configuration in which both the irradiation direction 2x and the imaging direction 4x can be changed.

The embodiment of the present disclosure has been described above in detail. The embodiment described above is merely a specific example of practicing the present disclosure. The details of the embodiments shall not be construed as limiting the technical scope of the present disclosure. A number of design modifications such as modification, addition, deletion, etc. of constituting elements may be made to the extent that they do not depart from the idea of the invention defined by the claims. New embodiments with design modifications will provide the combined advantages of the embodiment and the variation. Although the details subject to such design modification are emphasized in the embodiment by using phrases such as “of the embodiment” and “in the embodiment”, details not referred to as such are also subject to design modification. Any combination of the above constituting elements is also useful as an embodiment of the present disclosure. Hatching in the cross section in the drawings should not be construed as limiting the material of the hatched object.

The inventions according to embodiments 3, 4 described above may be defined by the items described below.

### Item 1

A lamp system (1) including:
an imaging apparatus (4) that images a scene in front of a vehicle;
a variable light distribution lamp (2) capable of forming a light distribution pattern (PTN) having a shielded-light portion (44);
a first bracket (8) that supports the imaging apparatus (4);
a second bracket (2) that supports the variable light distribution lamp (2) such that an irradiation direction (2x) is variable and that is independently displaceable with respect to the first bracket (8);
an irradiation direction sensor (12) that detects an amount of change in the irradiation direction (2x); and
a light distribution control apparatus (6) that sets, in an image (IMG) based on the imaging apparatus (4), a processing region (ROI) based on a mutual correspondence between an imaging direction (4x) of the imaging apparatus (4) and the irradiation direction (2x), performs an object detection process in the processing region (ROI) to detect an object, and controls the variable light distribution lamp (2) to form a light distribution pattern (PTN) having a shielded-light portion (44) corresponding to the object,
wherein the light distribution control apparatus (6) defines, when the irradiation direction (2x) is changed, the processing region (ROI) at a position shifted from the position of the processing region (ROI) defined based on a pre-change correspondence by an amount determined by the amount of change.

### Item 2

The lamp system (1) according to Item 1,
wherein the light distribution control apparatus (6):
stores information on the correspondence,
corrects the information based on the amount of change at a predetermined point of time, which is at least one of when an ignition switch is switched from off to on, when a vehicle speed exceeds 0, when a shift position is switched from a neutral range to another range, or when an accelerator is switched from off to on, and
defines the position of the processing region (ROI) by using corrected information.

### Item 3

The lamp system (1) according to Item 1 or Item 2,
wherein the lamp system (1) is mounted on a rideable saddle vehicle including a stand (ST) that supports a vehicle body (BD),
wherein the light distribution control apparatus (6):
stores information on the correspondence,
corrects the information based on the amount of change when the stand (ST) is switched from a standing position to a stowed position, and
defines the position of the processing region (ROI) by using corrected information.

### Item 4

The lamp system (1) according to any one of Item 1 through Item 3,
wherein the first bracket (8) supports the imaging apparatus (4) such that the imaging direction (4x) is variable, and the first bracket is displaceable independently with respect to the second bracket (10),
wherein the lamp system (1) includes an imaging direction sensor (14) that detects an amount of change in the imaging direction (4x), and
wherein the light distribution control apparatus (6) defines, when at least one of the irradiation direction (2x) or the imaging direction (4x) is changed, the processing region (ROI) at a position shifted from a position of the processing region (ROI) defined based on a pre-change correspondence by an amount determined by an amount of change in the irradiation direction (2x) and an amount of change in the imaging direction (4x).

### Item 5

A light distribution control apparatus (6) that sets, in an image (IMG) based on an imaging apparatus (4) that images a scene in front of a vehicle, a processing region (ROI) based on a mutual correspondence between an imaging direction (4x) of the imaging apparatus (4) and an irradiation direction (2x) of a variable light distribution lamp (2), performs an object detection process in the processing region (ROI) to detect an object, and controls the variable light distribution lamp (2) to form a light distribution pattern (PTN) having a shielded-light portion (44) corresponding to the object,
wherein the light distribution control apparatus (6):
acquires a detection result from an irradiation direction sensor (12) that detects an amount of change in the irradiation direction (2x), and
defines, when the irradiation direction (2x) is changed, the processing region (ROI) at a position shifted from the position of the processing region (ROI) defined based on a pre-change correspondence by an amount determined by the amount of change.

### Item 6

A light distribution control apparatus (6) that sets, in an image (IMG) based on an imaging apparatus (4) that images a scene in front of a vehicle, a processing region (ROI) based on a mutual correspondence between an imaging direction (4x) of the imaging apparatus (4) and an irradiation direction (2x) of a variable light distribution lamp (2), performs an object detection process in the processing region (ROI) to detect an object, and controls the variable light distribution lamp (2) to form a light distribution pattern (PTN) having a shielded-light portion (44) corresponding to the object,
wherein, while the imaging direction (4x) is fixed with respect to the object which remains at the same position relative to the vehicle,
the light distribution control apparatus defines the shielded-light portion (44) in the light distribution pattern (PTN) when the imaging direction (4x) and the irradiation direction (2x) are in a first correspondence and does not define the shielded-light portion (44) in the light distribution pattern (PTN) when the imaging direction (4x) and the irradiation direction (2x) are in a predetermined second correspondence different from the first correspondence.

### Item 7

A computer program executed by a light distribution control apparatus (6) that sets, in an image (IMG) based on an imaging apparatus (4) that images a scene in front of a vehicle, a processing region (ROI) based on a mutual correspondence between an imaging direction (4x) of the imaging apparatus (4) and an irradiation direction (2x) of a variable light distribution lamp (2), performs an object detection process in the processing region (ROI) to detect an object, and controls the variable light distribution lamp (2) to form a light distribution pattern (PTN) having a shielded-light portion (44) corresponding to the object,
wherein the computer program causes the light distribution control apparatus (6) to execute a function of acquiring a detection result from an irradiation direction sensor (12) that detects an amount of change in the irradiation direction (2x) and defining, when the irradiation direction (2x) is changed, the processing region (ROI) at a position shifted from the position of the processing region (ROI) defined based on a pre-change correspondence by an amount determined by the amount of change.

What is claimed is:

1. A lamp system comprising:
an imaging apparatus that images a scene in front of a vehicle;
a variable light distribution lamp capable of forming a light distribution pattern having a shielded-light portion;
a first bracket that supports the imaging apparatus; a second bracket that supports the variable light distribution lamp such that an irradiation direction is variable and that is independently displaceable with respect to the first bracket;
an irradiation direction sensor that detects an amount of change in the irradiation direction; and
a light distribution control apparatus that detects an object by using an image based on the imaging apparatus, defines a position of the shielded-light portion corresponding to the object based on a mutual correspondence between an imaging direction of the imaging apparatus and the irradiation direction, and controls the variable light distribution lamp to form the light distribution pattern having the shielded-light portion,
wherein the light distribution control apparatus defines, when the irradiation direction is changed, the shielded-light portion at a position shifted from the position of the shielded-light portion defined based on a pre-change correspondence by an amount determined by the amount of change.

2. The lamp system according to claim 1,
wherein the light distribution control apparatus:
stores information on the correspondence,
corrects the information based on the amount of change at a predetermined point of time, which is at least one of when an ignition switch is switched from off to on, when a vehicle speed exceeds 0, when a shift position is switched from a neutral range to another range, or when an accelerator is switched from off to on, and
defines the position of the shielded-light portion by using corrected information.

3. The lamp system according to claim 1,
wherein the lamp system is mounted on a rideable saddle vehicle including a stand that supports a vehicle body,
wherein the light distribution control apparatus:
stores information on the correspondence,
corrects the information based on the amount of change when the stand is switched from a standing position to a stowed position, and
defines the position of the shielded-light portion by using corrected information.

4. The lamp system according to claim 1,
wherein the first bracket supports the imaging apparatus such that the imaging direction is variable, and the first bracket is displaceable independently with respect to the second bracket,
wherein the lamp system includes an imaging direction sensor that detects an amount of change in the imaging direction, and
wherein the light distribution control apparatus defines, when at least one of the irradiation direction or the imaging direction is changed, the shielded-light portion at a position shifted from a position of the shielded-light portion defined based on a pre-change correspondence by an amount determined by an amount of change in the irradiation direction and an amount of change in the imaging direction.

5. A light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion,
wherein the light distribution control apparatus:
acquires a detection result from an irradiation direction sensor that detects an amount of change in the irradiation direction, and
defines, when the irradiation direction is changed, the shielded-light portion at a position shifted from the position of the shielded-light portion defined based on a pre-change correspondence by an amount determined by the amount of change.

6. A light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion,
wherein, while the imaging direction is fixed with respect to the object which remains at the same position relative to the vehicle,
the light distribution control apparatus defines the shielded-light portion at a first position in the light distribution pattern when the imaging direction and the irradiation direction are in a first correspondence and defines the shielded-light portion at a second position in the light distribution pattern shifted from the first position when the imaging direction and the irradiation direction are in a second correspondence different from the first correspondence.

7. A computer program executed by a light distribution control apparatus that detects an object by using an image based on an imaging apparatus that images a scene in front of a vehicle, defines a position of a shielded-light portion corresponding to the object based on a mutual correspondence between an imaging direction of the imaging apparatus and an irradiation direction of a variable light distribution lamp, and controls the variable light distribution lamp to form a light distribution pattern having the shielded-light portion,
wherein the computer program causes the light distribution control apparatus to execute a function of acquiring a detection result from an irradiation direction sensor that detects an amount of change in the irradiation direction and defining, when the irradiation direction is changed, the shielded-light portion at a position shifted from the position of the shielded-light portion defined based on a pre-change correspondence by an amount determined by the amount of change.

8. A lamp system comprising:
an imaging apparatus that images a scene in front of a vehicle;
a variable light distribution lamp capable of forming a light distribution pattern having a shielded-light portion;
a first bracket that supports the imaging apparatus;
a second bracket that supports the variable light distribution lamp such that an irradiation direction is variable and that is independently displaceable with respect to the first bracket;
an irradiation direction sensor that detects an amount of change in the irradiation direction; and
a light distribution control apparatus that sets, in an image based on the imaging apparatus, a processing region based on a mutual correspondence between an imaging direction of the imaging apparatus and the irradiation direction, performs an object detection process in the processing region to detect an object, and controls the variable light distribution lamp to form a light distribution pattern having a shielded-light portion corresponding to the object,
wherein the light distribution control apparatus defines, when the irradiation direction is changed, the processing region at a position shifted from the position of the processing region defined based on a pre-change correspondence by an amount determined by the amount of change.

9. The lamp system according to claim 8,
wherein the light distribution control apparatus:
stores information on the correspondence,
corrects the information based on the amount of change at a predetermined point of time, which is at least one of when an ignition switch is switched from off to on, when a vehicle speed exceeds 0, when a shift position is switched from a neutral range to another range, or when an accelerator is switched from off to on, and
defines the position of the processing region by using corrected information.

10. The lamp system according to claim 8,
wherein the lamp system is mounted on a rideable saddle vehicle including a stand that supports a vehicle body,
wherein the light distribution control apparatus:
stores information on the correspondence,
corrects the information based on the amount of change when the stand is switched from a standing position to a stowed position, and
defines the position of the processing region by using corrected information.

11. The lamp system according to claim 8,
wherein the first bracket supports the imaging apparatus such that the imaging direction is variable, and the first bracket is displaceable independently with respect to the second bracket,
wherein the lamp system includes an imaging direction sensor that detects an amount of change in the imaging direction, and
wherein the light distribution control apparatus defines, when at least one of the irradiation direction or the imaging direction is changed, the processing region at a position shifted from a position of the processing region defined based on a pre-change correspondence by an amount determined by an amount of change in the irradiation direction and an amount of change in the imaging direction.

12. A light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object,
wherein the light distribution control apparatus:
acquires a detection result from an irradiation direction sensor that detects an amount of change in the irradiation direction, and
defines, when the irradiation direction is changed, the processing region at a position shifted from the position of the processing region defined based on a pre-change correspondence by an amount determined by the amount of change.

13. A light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object,
wherein, while the imaging direction is fixed with respect to the object which remains at the same position relative to the vehicle,
the light distribution control apparatus defines the shielded-light portion in the light distribution pattern when the imaging direction and the irradiation direction are in a first correspondence and does not define the shielded-light portion in the light distribution pattern when the imaging direction and the irradiation direction are in a predetermined second correspondence different from the first correspondence.

14. A computer program executed by a light distribution control apparatus that sets, in an image based on an imaging apparatus that images a scene in front of a vehicle, a processing region based on a mutual correspondence between an imaging direction of the imaging apparatus and an irradiation direction of a variable light distribution lamp, performs an object detection process in the processing region to detect an object, and controls the variable light distribution lamp to form a light distribution pattern having a shielded-light portion corresponding to the object,
wherein the computer program causes the light distribution control apparatus to execute a function of acquiring a detection result from an irradiation direction sensor that detects an amount of change in the irradiation direction and defining, when the irradiation direction is changed, the processing region at a position shifted from the position of the processing region defined based on a pre-change correspondence by an amount determined by the amount of change.
